(19) United States
(12) Patent Application Publication
(10) Pub. No.: US 2010/0324925 A1
(43) Pub. Date: Dec. 23, 2010

(54) METHOD, SYSTEM AND COMPUTER PROGRAM PRODUCT FOR EVALUATING A STATUS OF A PATIENT

(76) Inventors: Rafael Barkan, Rishon-Le'tziyon (IL); Ygal Shasha, Ramat Gan (IL)

Correspondence Address: RECHES PATENTS, 211 North Union St., Suite 100, Alexandria, VA, 22314, US

(21) Appl. No.: 12/663,471

(22) PCT Filed: May 6, 2008
(86) PCT No.: PCT/IL08/00627

§ 371 Date: Sep. 6, 2010

Related U.S. Application Data
(60) Provisional application No. 60/928,077, filed on May 8, 2007.

(51) Int. Cl. G06Q 50/00

(52) U.S. Cl. 705/2

(57) ABSTRACT

A method for evaluating a status of a patient, the method includes: receiving a medical care schedule that comprises multiple medical care actions that should be taken and desired medical results; providing a desired event sequence that represents the medical care schedule; wherein the desired event schedule comprises at least one multi-meta-event; generating an actual event sequence by processing multiple events representative of the actual medical care action taken in relation to the patient and of at least one measured medical result obtained from a patient; wherein the actual event schedule comprises at least one multi-meta event; comparing the desired event sequence to the actual event sequence to provide a comparison result; and assisting in generating a comparison result indication; wherein a multi-meta-event is representative of an outcome of an appliance of a logic operation on multiple events.

### RELATED APPLICATION

This application claims the priority of U.S. provisional patent 60/928,077 filing date May 8 2007 which is incorporated herein by reference.

### FIELD OF THE INVENTION

This invention relates to the field of data modeling and analysis of medical information.

### BACKGROUND OF THE INVENTION

Modern computer technology enables recording and tracking of numerous types of activities within medical systems and/or organizations. This plethora of information makes it difficult for analysts and decision makers to make sense of all the recorded information and identify the many processes that exist within a system or an organization. In many cases this problem is exacerbated because the data does not undergo any processing, and is saved in its raw form.

Currently, information related to patients is analyzed with the aid of data mining tools and/or analysts, who formulate complex database queries. Analysts are then required to gather all the relevant information, go through all the relevant data points, and only then can they analyze the data and form hypotheses based on the information gathered.

Systems and organizations are engaged in activities that are becoming more and more complex. In addition, advances in computer technology enable recording and tracking of numerous types of activities within systems and/or organizations. Medical information is stored in Health Care Information Technology (HCIT) systems, which solve the problems of data storage, uniformity, accessibility, and mobility. Analysts and decision makers turn to these systems to access the data, analyze it, form hypothesis and make decisions based on the stored data. However, the plethora of recorded information makes it difficult to make sense of all the recorded information and identify the many processes that exist within a system or an organization. While current generation HCIT systems improved dramatically the recording, unification, and access to medical data, the physicians and administrators are still left with the task of comprehending and analyzing the raw data these systems recorded.

The data models that are used in current HCIT products concentrate on unifying data from different sources and formats, and on providing accessibility and classical database analysis to the data (e.g., current HCIT tools provided by Microsoft, Oracle and SAP).

Current analysis tools include database queries and data mining tools. Database queries enable answering questions by retrieving discrete data points. They can also perform simple manipulations (such as aggregations) on the recorded data and show specific cross sections and trends. An analyst or a system can then generate measures and indicators based on the result of one or more queries and track the changes of these indicators over time.

Data mining tools can automatically identify correlations between two or more discrete data points. These correlations may help in identifying connections between different agents in the systems, but it is often hard to understand why these correlations occur.

Thus, the current data models and tools make it difficult to identify, understand, and analyze various processes that are embedded in the raw data and occur within the medical system and/or organization (e.g., administrative, professional, and organizational processes).

### SUMMARY OF THE INVENTION

A method for evaluating a status of a patient, the method includes: receiving a medical care schedule that includes multiple medical care actions that should be taken and desired medical results; providing a desired event sequence that represents the medical care schedule; wherein the desired event schedule includes at least one multi-meta-event; generating an actual event sequence by processing multiple events representative of the actual medical care action taken in relation to the patient and of at least one measured medical result obtained from at patient; wherein the actual event schedule includes at least one multi-meta-event; comparing the desired event sequence to the actual event sequence to provide a comparison result; and assisting in generating a comparison result indication; wherein a multi-meta-event is representative of an outcome of an appliance of a logic operation on multiple events or of an appliance of a logic operation on attributes of multiple events. The method for processing includes classifying base events, categorizing base events, comparing multiple base events, merging multiple base events, and filtering base events.

Conveniently, the processing includes inferring base events in response to the desired event sequence.

Conveniently, the processing includes calculating measures associated with the patient and associated with a time frame.

Conveniently, the method includes: filtering comparison results portions to be displayed based upon medical specialties of interest; and generating a visual representation of a filtered comparison result.

Conveniently, the method includes determining a patient status from the comparison result and assisting in displaying a patient status indication.

Conveniently, the method includes assisting in displaying multiple medical care actions that should be taken in the future and expected medical consequences of non-compliance with the medical care schedule.

Conveniently, the method includes evaluating a patient contribution to an efficiency of the medical care schedule and evaluating a practitioner contribution to an efficiency of the medical care schedule.

Conveniently, the method includes evaluating an efficiency of the medical care schedule, evaluating a patient contribution to an efficiency of the medical care schedule and evaluating a practitioner contribution to an efficiency of the medical care schedule.

A method for evaluating a status of a patient is provide, the method includes: determining the status of the patient; assisting in displaying, in a medical specialty grouped manner, at least one element selected from a group consisting of: expected medical consequences of complying with the medical care schedule; expected medical consequences of non-compliance with the medical care schedule; typical medical complications associated with the status of the patient; and typical medical complications associated with the status of the patient and typical medical care actions to be taken in response to the typical medical complications.

Conveniently, the method includes determining the status of the patient based upon a comparison between an actual event sequence and a desired event sequence that represents a medical care schedule.

Conveniently, the method includes: determining, in response to the status of the patient, a relevancy of multiple medical care actions and of multiple medical results; and displaying, in a medical specialty grouped manner, the multiple medical care actions and the multiple medical results in a manner that is indicative of a relevancy of each medical care action and of each medical result.

Conveniently, the method includes generating a graphical representation of links between multiple relevant medical care actions and multiple relevant medical results.

Conveniently, the method includes determining a relevancy time window and assisting in displaying, in a medical specialty grouped manner, at least one element selected from a group consisting of: expected medical consequences that should occur within the relevancy time window, of complying with the medical care schedule; expected medical consequences that should occur within the relevancy time window, of non-compliance with the medical care schedule; typical medical complications that should occur within the relevancy time window, that are associated with the status of the patient; and typical medical complications that should occur within the relevancy time window that are associated with the status of the patient and typical medical care actions to be taken within the relevancy time window, in response to the typical medical complications.

A method for generating a data structure indicative of health of multiple patients is provided, the method includes: receiving multiple medical care schedules; each medical care schedule includes multiple medical care actions that should be taken and desired medical results; providing, for each medical care schedule out of the multiple medical care schedules, a desired event sequence that represents the medical care schedule; receiving, for each patient, base events representative of actual medical care action taken in relation to the patient and of at least one measured result obtained from the patient; processing the base events to provide stored events by applying at least one operations selected from a list consisting of: merging a continuous sequence of base events that equal to each other; generating an event that represents a difference between two consecutive base event of the same type; and inferring an event that represent an absence of an expected base event; generating an actual event sequence, for each patient out of the multiple patient, by processing multiple stored events; receiving a query relating to a relationship between a desired event sequence associated with a patient to an actual event sequence of the patient; and providing a response to the query.

Conveniently, the method includes processing the base events to provide stored events by applying at least two operations selected from a list consisting of: merging a continuous sequence of base events that equal to each other; generating an event that represents a difference between two consecutive base event of the same type; inferring an event that represent an absence of an expected base event; and generating an actual event sequence, for each patient out of the multiple patient, by processing multiple stored events.

Conveniently, the method includes: assisting in displaying, in a medical specialty grouped manner, at least one element selected from a group consisting of: expected medical consequences of complying with the medical care schedule; expected medical consequences of non-compliance with the medical care schedule; typical medical complications associated with the status of the patient; and typical medical complications associated with the status of the patient and typical medical care actions to be taken in response to the typical medical complications.

A method for evaluating a status of a patient is provided, the method includes: receiving a medical care schedule that includes multiple medical care actions that should be taken and desired medical results; and generating an actual event sequence by processing multiple events representative of the actual medical care action taken in relation to the patient and of at least one measured medical result obtained from at patient; wherein the actual event schedule includes at least one multi-meta-event; and assisting in generating a patient status indication; wherein a multi-meta-event is representative of an outcome of an appliance of a logic operation on multiple events or of an appliance of a logic operation on attributes of multiple events.

Conveniently, the method includes: providing a desired event sequence that represents the medical care schedule; wherein the desired event schedule includes at least one multi-meta-event; comparing the desired event sequence to the actual event sequence to provide a comparison result; and wherein the assisting includes generating a comparison result indication.

Conveniently, the method generating of the actual event sequence includes comparing medical results to expected medical results.

A method for generating a data structure indicative of health of multiple patients is provided, the method includes: receiving, for each patient, base events representative of actual medical care action taken in relation to the patient and of at least one measured result obtained from the patient; processing the base events to provide stored events by applying at least one operations selected from a list consisting of: merging a continuous sequence of base events that equal to each other; generating an event that represents a difference between two consecutive base event of the same type; and inferring an event that represent an absence of an expected base event; and generating an actual event sequence, for each patient out of the multiple patient, by processing multiple stored events.

Conveniently, the method includes receiving a query relating to a status of the patient; and providing a response to the query.

A method for responding to a query relating to a status of a patient is provided, the method includes: receiving a query relating to a status of the patient; accessing a data structure indicative of health of multiple patients; and providing a response to the query; wherein the data structure indicative of health of multiple patients includes an actual event sequence, for each patient out of the multiple patient; wherein the actual event sequence was generated by processing multiple base events.

Conveniently, the actual event sequence was generated by applying at least one operations selected from a list consisting of: merging a continuous sequence of base events that equal to each other; generating an event that represents, a difference between two consecutive base event of the same type; and inferring an event that represent an absence of an expected base event; and generating an actual event sequence, for each patient out of the multiple patient, by processing multiple stored events.

Conveniently, the actual event sequence includes at least one multi-meta-event.

A computer readable medium that stores computer readable instructions for: receiving a medical care schedule that includes multiple medical care actions that should be taken and desired medical results; providing a desired event sequence that represents the medical care schedule; wherein the desired event schedule includes at least one multi-meta-event; generating an actual event sequence by processing multiple events representative of the actual medical care action taken in relation to the patient and of at least one measured medical result obtained from at patient; wherein the actual event schedule includes at least one multi-meta-event; comparing the desired event sequence to the actual event sequence to provide a comparison result; and assisting in generating a comparison result indication; wherein a multi-meta-event is representative of an outcome of an appliance of a logic operation on multiple events or of an appliance of a logic operation on attributes of multiple events.

Conveniently, the computer readable medium that stores computer readable instructions for classifying base events, categorizing base events, comparing multiple base events, merging multiple base events, and filtering base events.

Conveniently, the computer readable medium that stores computer readable instructions for inferring base events in response to the desired event sequence.

Conveniently, the computer readable medium that stores computer readable instructions for calculating measures associated with the patient and associated with a time frame.

Conveniently, the computer readable medium that stores computer readable instructions for: filtering comparison results portions to be displayed based upon medical specialties of interest; and generating a visual representation of a filtered comparison result.

Conveniently, the computer readable medium that stores computer readable instructions for determining a patient status from the comparison result and assisting in displaying a patient status indication.

Conveniently, the computer readable medium includes assisting in displaying multiple medical care actions that should be taken in the future and expected medical consequences of non-compliance with the medical care schedule.

Conveniently, the computer readable medium that stores computer readable instructions for evaluating a patient contribution to an efficiency of the medical care schedule and evaluating a practitioner contribution to an efficiency of the medical care schedule.

Conveniently, the computer readable medium that stores computer readable instructions for evaluating an efficiency of the medical care schedule, evaluating a patient contribution to an efficiency of the medical care schedule and evaluating a practitioner contribution to an efficiency of the medical care schedule.

A computer readable medium that stores computer readable instructions for is provided: determining the status of the patient; assisting in displaying, in a medical specialty grouped manner, at least one element selected from a group consisting of: expected medical consequences of complying with the medical care schedule; expected medical consequences of non-compliance with the medical care schedule; typical medical complications associated with the status of the patient; and typical medical complications associated with the status of the patient and typical medical care actions to be taken in response to the typical medical complications.

Conveniently, the computer readable medium that stores computer readable instructions for determining the status of the patient based upon a comparison between an actual event sequence and a desired event sequence that represents a medical care schedule.

Conveniently, the computer readable medium that stores computer readable instructions for: determining, in response to the status of the patient, a relevancy of multiple medical care actions and of multiple medical results; and displaying, in a medical specialty grouped manner, the multiple medical care actions and the multiple medical results in a manner that is indicative of a relevancy of each medical care action and of each medical result.

Conveniently, the computer readable medium that stores computer readable instructions for generating a graphical representation of links between multiple relevant medical care actions and multiple relevant medical results.

Conveniently, the computer readable medium that stores computer readable instructions for determining a relevancy time window and assisting in displaying, in a medical specialty grouped manner, at least one element selected from a group consisting of: expected medical consequences that should occur within the relevancy time window, of complying with the medical care schedule; expected medical consequences that should occur within the relevancy time window, of non-compliance with the medical care schedule; typical medical complications that should occur within the relevancy time window, that are associated with the status of the patient; and typical medical complications that should occur within the relevancy time window that are associated with the status of the patient and typical medical care actions to be taken within the relevancy time window, in response to the typical medical complications.

A computer readable medium that stores computer readable instructions is provided for: receiving multiple medical care schedules; each medical care schedule includes multiple medical care actions that should be taken and desired medical results; providing, for each medical care schedule out of the multiple medical care schedules, a desired event sequence that represents the medical care schedule; receiving, for each patient, base events representative of actual medical care action taken in relation to the patient and of at least one measured result obtained from the patient; processing the base events to provide stored events by applying at least one operations selected from a list consisting of: merging a continuous sequence of base events that equal to each other; generating an event that represents a difference between two consecutive base event of the same type; and inferring an event that represent an absence of an expected base event; generating an actual event sequence, for each patient out of the multiple patient, by processing multiple stored events; receiving a query relating to a relationship between a desired event sequence associated with a patient to an actual event sequence of the patient; and providing a response to the query.

Conveniently, the computer readable medium that stores computer readable instructions for: processing the base events to provide stored events by applying at least two operations selected from a list consisting of: merging a continuous sequence of base events that equal to each other; generating an event that represents a difference between two consecutive base event of the same type; inferring an event that represent an absence of an expected base event; and generating an actual event sequence, for each patient out of the multiple patient, by processing multiple stored events.

Conveniently, the computer readable medium that stores computer readable instructions for: assisting in displaying, in a medical specialty grouped manner, at least one element selected from a group consisting of: expected medical consequences of complying with the medical care schedule; expected medical consequences of non-compliance with the medical care schedule; typical medical complications associated with the status of the patient; and typical medical complications associated with the status of the patient and typical medical care actions to be taken in response to the typical medical complications.

Conveniently, a computer readable medium that stores computer readable instructions for: receiving a medical care schedule that includes multiple medical care actions that should be taken and desired medical results; generating an actual event sequence by processing multiple events representative of the actual medical care action taken in relation to the patient and of at least one measured medical result obtained from at patient; wherein the actual event schedule includes at least one multi-meta-event; and assisting in generating a patient status indication; wherein a multi-meta-event is representative of an outcome of an appliance of a logic operation on multiple events or of an appliance of a logic operation on attributes of multiple events.

Conveniently, the computer readable medium that stores computer readable instructions for: providing a desired event sequence that represents the medical care schedule; wherein the desired event schedule includes at least one multi-meta-event; comparing the desired event sequence to the actual event sequence to provide a comparison result; and wherein the assisting includes generating a comparison result indication.

Conveniently, the computer readable medium that stores computer readable instructions for comparing medical results to expected medical results.

A computer readable medium that stores computer readable instructions is provided for: receiving, for each patient, base events representative of actual medical care action taken in relation to the patient and of at least one measured result obtained from the patient; processing the base events to provide stored events by applying at least one operations selected from a list consisting of: merging a continuous sequence of base events that equal to each other; generating an event that represents a difference between two consecutive base event of the same type; and inferring an event that represent an absence of an expected base event; and generating an actual event sequence, for each patient out of the multiple patient, by processing multiple stored events.

Conveniently, the computer readable medium that stores computer readable instructions for receiving a query relating to a status of the patient; and providing a response to the query.

Conveniently, a computer readable medium that stores computer readable instructions for: receiving a query relating to a status of the patient; accessing a data structure indicative of health of multiple patients; and providing a response to the query; wherein the data structure indicative of health of multiple patients includes an actual event sequence, for each patient out of the multiple patient; wherein the actual event sequence was generated by processing multiple base events.

Conveniently, the computer readable medium that stores computer readable instructions for generating the actual event sequence by applying at least one operations selected from a list consisting of: merging a continuous sequence of base events that equal to each other; generating an event that represents a difference between two consecutive base event of the same type; and inferring an event that represent an absence of an expected base event; and generating an actual event sequence, for each patient out of the multiple patient, by processing multiple stored events.

Conveniently, the computer readable medium wherein an actual event sequence includes at least one multi-meta-event.

A system for evaluating a status of a patient is provided, the system includes: a memory unit for storing a medical care schedule that includes multiple medical care actions that should be taken and desired medical results; a processor that is adapted to: provide a desired event sequence that represents the medical care schedule; wherein the desired event schedule includes at least one multi-meta-event; generate an actual event sequence by processing multiple events representative of the actual medical care action taken in relation to the patient and of at least one measured medical result obtained from at patient; wherein the actual event schedule includes at least one multi-meta-event; compare the desired event sequence to the actual event sequence to provide a comparison result; and assist in generating a comparison result indication; wherein a multi-meta-event is representative of an outcome of an appliance of a logic operation on multiple events or of an appliance of a logic operation on attributes of multiple events.

Conveniently, the processor is adapted to classify base events, categorizing base events, comparing multiple base events, merging multiple base events, and filtering base events.

Conveniently, the processor is adapted to infer base events in response to the desired event sequence.

Conveniently, the processor is adapted to calculate measures associated with the patient and associated with a time frame.

Conveniently, the processor is adapted to: filter comparison results portions to be displayed based upon medical specialties of interest; and generate a visual representation of a filtered comparison result.

Conveniently, the processor is adapted to determine a patient status from the comparison result and assisting in displaying a patient status indication.

Conveniently, the processor is adapted to assist in displaying multiple medical care actions that should be taken in the future and expected medical consequences of non-compliance with the medical care schedule.

Conveniently, the processor is adapted to evaluate a patient contribution to an efficiency of the medical care schedule and evaluating a practitioner contribution to an efficiency of the medical care schedule.

Conveniently, the processor is adapted to evaluate an efficiency of the medical care schedule, evaluating a patient contribution to an efficiency of the medical care schedule and evaluating a practitioner contribution to an efficiency of the medical care schedule.

A system for evaluating a status of a patient is provided, the system includes: A memory unit coupled to a processor, wherein the processor is adapted to determine the status of the patient and assist in displaying, in a medical specialty grouped manner, at least one element selected from a group consisting of: expected medical consequences of complying with the medical care schedule; expected medical consequences of non-compliance with the medical care schedule; typical medical complications associated with the status of the patient; and typical medical complications associated with the status of the patient and typical medical care actions to be taken in response to the typical medical complications.

Conveniently, the processor is adapted to determine the status of the patient based upon a comparison between an actual event sequence and a desired event sequence that represents a medical care schedule.

Conveniently, the processor is adapted to: determine, in response to the status of the patient, a relevancy of multiple medical care actions and of multiple medical results; and display, in a medical specialty grouped manner, the multiple medical care actions and the multiple medical results in a manner that is indicative of a relevancy of each medical care action and of each medical result.

Conveniently, the processor is adapted to generate a graphical representation of links between multiple relevant medical care actions and multiple relevant medical results.

Conveniently, the processor is adapted to determine a relevancy time window and assisting in displaying, in a medical specialty grouped manner, at least one element selected from a group consisting of: expected medical consequences that should occur within the relevancy time window, of complying with the medical care schedule; expected medical consequences that should occur within the relevancy time window, of non-compliance with the medical care schedule; typical medical complications that should occur within the relevancy time window, that are associated with the status of the patient; and typical medical complications that should occur within the relevancy time window that are associated with the status of the patient and typical medical care actions to be taken within the relevancy time window, in response to the typical medical complications.

A system for generating a data structure indicative of health of multiple patients is provided, the system includes a memory unit coupled to a processor, the memory unit is adapted to store multiple medical care schedules; each medical care schedule includes multiple medical care actions that should be taken and desired medical results; the processor is adapted to: receive multiple medical care schedules; each medical care schedule includes multiple medical care actions that should be taken and desired medical results; provide, for each medical care schedule out of the multiple medical care schedules, a desired event sequence that represents the medical care schedule; receive, for each patient, base events representative of actual medical care action taken in relation to the patient and of at least one measured result obtained from the patient; process the base events to provide stored events by applying at least one operations selected from a list consisting of: merging a continuous sequence of base events that equal to each other; generating an event that represents a difference between two consecutive base event of the same type; and inferring an event that represent an absence of an expected base event; generating an actual event sequence, for each patient out of the multiple patient, by processing multiple stored events; receiving a query relating to a relationship between a desired event sequence associated with a patient to an actual event sequence of the patient; and providing a response to the query.

Conveniently, the processor is adapted to: process the base events to provide stored events by applying at least two operations selected from a list consisting of: merge a continuous sequence of base events that equal to each other; generate an event that represents a difference between two consecutive base event of the same type; infer an event that represent an absence of an expected base event; and generate an actual event sequence, for each patient out of the multiple patient, by processing multiple stored events.

Conveniently, the processor is adapted to: assist in displaying, in a medical specialty grouped manner, at least one element selected from a group consisting of: expected medical consequences of complying with the medical care schedule; expected medical consequences of non-compliance with the medical care schedule; typical medical complications associated with the status of the patient; and typical medical complications associated with the status of the patient and typical medical care actions to be taken in response to the typical medical complications.

A system for evaluating a status of a patient is provided, the system includes: a memory unit adapted to store a medical care schedule that includes multiple medical care actions that should be taken and desired medical results; and a processor adapted to generate an actual event sequence by processing multiple events representative of the actual medical care action taken in relation to the patient and of at least one measured medical result obtained from at patient; wherein the actual event schedule includes at least one multi-meta-event; and assisting in generating a patient status indication; wherein a multi-meta-event is representative of an outcome of an appliance of a logic operation on multiple events or of an appliance of a logic operation on attributes of multiple events.

Conveniently, the processor is adapted to: provide a desired event sequence that represents the medical care schedule; wherein the desired event schedule includes at least one multi-meta-event; comparing the desired event sequence to the actual event sequence to provide a comparison result; and wherein the assisting includes generating a comparison result indication.

Conveniently, the processor is adapted to compare medical results to expected medical results.

A system for generating a data structure indicative of health of multiple patients is provided, the system includes: a memory unit for storing, for each patient, base events representative of actual medical care action taken in relation to the patient and of at least one measured result obtained from the patient; a processor that is adapted to process the base events to provide stored events by applying at least one operations selected from a list consisting of: merging a continuous sequence of base events that equal to each other; generating an event that represents a difference between two consecutive base event of the same type; and inferring an event that represent an absence of an expected base event; and generating an actual event sequence, for each patient out of the multiple patient, by processing multiple stored events.

Conveniently, the system adapted to receive a query relating to a status of the patient; and provide a response to the query.

Conveniently, the system for responding to a query relating to a status of a patient, the system includes: a memory unit for storing a query relating to a status of the patient; a processor for access a data structure indicative of health of multiple patients; and provide a response to the query; wherein the data structure indicative of health of multiple patients includes an actual event sequence, for each patient out of the multiple patient; wherein the actual event sequence was generated by processing multiple base events.

Conveniently, the actual event sequence was generated by applying at least one operations selected from a list consisting of: merging a continuous sequence of base events that equal to each other; generating an event that represents a difference between two consecutive base event of the same type; and inferring an event that represent an absence of an expected base event; and generating an actual event sequence, for each patient out of the multiple patient, by processing multiple stored events.

Conveniently, an actual event sequence includes at least one multi-meta-event.

### BRIEF DESCRIPTION OF THE DRAWINGS

The foregoing and other objects, features, and advantages of the present invention will become more apparent from the following detailed description when taken in conjunction with the accompanying drawings. In the drawings, similar reference characters denote similar elements throughout the different views, in which:

FIG. 1 illustrates a base event that includes an actor identifier, an event identifier, and a timestamp, according to an embodiment of the invention;

FIG. 2 illustrates an example of classification in action, according to an embodiment of the invention;

FIG. 3 illustrates a categorization, according to an embodiment of the invention;

FIG. 4 illustrates a comparison, according to an embodiment of the invention;

FIG. 5 illustrates merging, according to an embodiment of the invention;

FIG. 6 illustrates an inferred event, according to an embodiment of the invention;

FIG. 7 illustrates an event sequence, according to an embodiment of the invention;

FIG. 8 illustrates an event sequence demonstrating the cost measure, according to an embodiment of the invention;

FIG. 9 illustrates the cost attributes of events in the system, according to an embodiment of the invention;

FIG. 10 illustrates a progression of the cost measure in time, as the patient interacts with the medical provider, according to an embodiment of the invention;

FIG. 11 illustrates a list of the events that are created by the system and can appear in the primary sequence, according to an embodiment of the invention;

FIG. 12 illustrates a primary sequence of Actor B, according to an embodiment of the invention;

FIG. 13 illustrates a Primary Sequence Repository is an aggregation of the primary sequences of all the actors, according to an embodiment of the invention;

FIG. 14 illustrates a generation of an analysis sequence out of a primary sequence for Actor B, according to an embodiment of the invention;

FIG. 15 illustrates an Analysis Sequence Repository is an aggregation of the analysis sequences of all the actors, according to an embodiment of the invention;

FIG. 16 illustrates an Analysis Model filtered by date, according to an embodiment of the invention;

FIG. 17 illustrates events E12, E13, and E14 that are now mapped to event E12G, according to an embodiment of the invention;

FIG. 18 illustrates a definition of a meta-event, MEA, defined as an occurrence of either event E2 or event E3, according to an embodiment of the invention;

FIG. 19 illustrates a definition of a meta-events MEA (see FIG. 15), and MEB, defined as an occurrence of either event E4 or event E15, according to an embodiment of the invention;

FIG. 20 illustrates the MDS for the query described in FIG. 18, according to an embodiment of the invention;

FIG. 21 illustrates an example of a query that looks for the SME: MEA→MEB but does not permit the occurrence of event E7 within the sequence, according to an embodiment of the invention;

FIG. 22 illustrates a defined Subset of Sequences (DSS) of a query, according to an embodiment of the invention;

FIG. 23 illustrates a meta-event defined Subsequence (MDS) of a query, according to an embodiment of the invention;

FIG. 24 illustrates the visual medium that is divided into areas according to the application logic, according to an embodiment of the invention;

FIG. 25 illustrates the visual medium that displays events related to diabetic treatment, according to an embodiment of the invention;

FIG. 26 illustrates the visual medium that depicts a sequence experienced by some patients, according to an embodiment of the invention;

FIG. 27 illustrates a sequence, according to an embodiment of the invention;

FIG. 28 illustrates a sequence, according to an embodiment of the invention;

FIG. 29 illustrates a work flow that generates the event sequence repository (ESR), according to an embodiment of the invention;

FIG. 30 presents a description of this part of the software, according to an embodiment of the invention;

FIG. 31 illustrates a detailed description of a possible process for generating Event Sequence Repository from existing databases, where the raw information is stored, according to an embodiment of the invention;

FIG. 32, that is an XML representation of a single event, according to an embodiment of the invention;

FIG. 33 illustrates a method for evaluating a status of a patient according to an embodiment of the invention;

FIG. 34 illustrates a method for evaluating a status of a patient according to an embodiment of the invention;

FIG. 35 illustrates a method for generating a data structure indicative of health of multiple patients according to an embodiment of the invention; and

FIGS. 36 and 37 illustrate a report that includes lab test results, physical examination results, medical treatment information, visits to a medical center and diagnosis according to an embodiment of the invention; and

FIGS. 38-43 illustrate various processes and data structures according to various embodiments of the invention.

### DETAILED DESCRIPTION OF THE DRAWINGS

The terms “patient”, “actors” have the same meaning and indicate a person that his health is being monitored, and additionally or alternatively, his compliance with a medical care schedule is determined.

A method, system and computer program product are provided. They enable to determine a state of a patient, to provide efficient data structures and to display health related information is an innovative manner.

It is noted that the following description can refer to one element out of a “method”, a “system” or a “computer program product”. It is noted that this reference also applies to the other two elements.

Conveniently, the system, the method and the computer program product utilize raw data to create meaningful representations of the recorded data. They first translate the recorded data into meaningful events, and aggregate the events of all actors over a period of time and generate a repository of event sequences. This repository can then be used to either identify or formulate processes that occur within a medical system and/or an organization and are not necessarily evident from the data.

The method, computer program product and the system create a meaningful event-based language that can aid investigating and understanding the knowledge embedded in the data (but not necessarily evident from it).

The method, computer program product and the system represent the data collected at the organization databases as a series of processes each patient undergoes, without dissecting it into different elements (e.g., drug treatments, lab tests, procedures, visits with specialists etc). When aggregated over population of patients, healthcare administrators and researchers are provided with a unique data model and multi-dimensional visualization of the occurring medical processes. In addition, they can easily form process-based hypotheses and test their validity. Performing these kinds of analyses with current healthcare technologies is so complex that most organizations perform them at a rudimentary level, if at all.

The proposed method, system and computer program product create (one or more) mappings of the recorded data into sets of events according to specific mapping rules. An event represents an incident that occurs to an actor in the organization and/or system. The mapping rules translate the recorded data into meaningful events in time. The events are then ordered chronologically in time to form a specific layer based on the context embodied in the mapping rules. This representation allows identifying, describing, and understanding processes that actors experience.

The following paragraphs describe a sample data model. The data recorded in HCIT systems (that is, raw data) is mapped into events.

A base event is typically a one-to-one mapping of a raw datum into a single unit of knowledge consisting of: an actor identifier, timestamp or a sequence identifier, an event identifier, and zero or more attributes that describe the event.

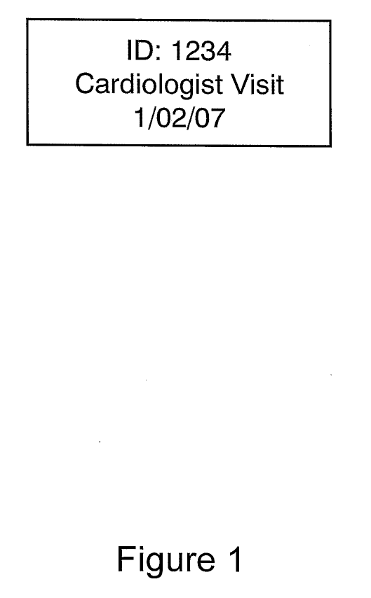

FIG. 1 illustrates a base event that includes an actor identifier, an event identifier, and a timestamp, according to an embodiment of the invention. The illustrated event includes an actor identifier (1234), an event identifier (Cardiologist Visit), and a timestamp (Jan. 2, 2007)

Specific operations (also referred to as manipulations) can be performed on these base events enables to define new types of events, which will be referred to as processed events.

Classification—several base events can be mapped into a single event. The mapping is based on the event identification and/or one (or more) of its attributes.

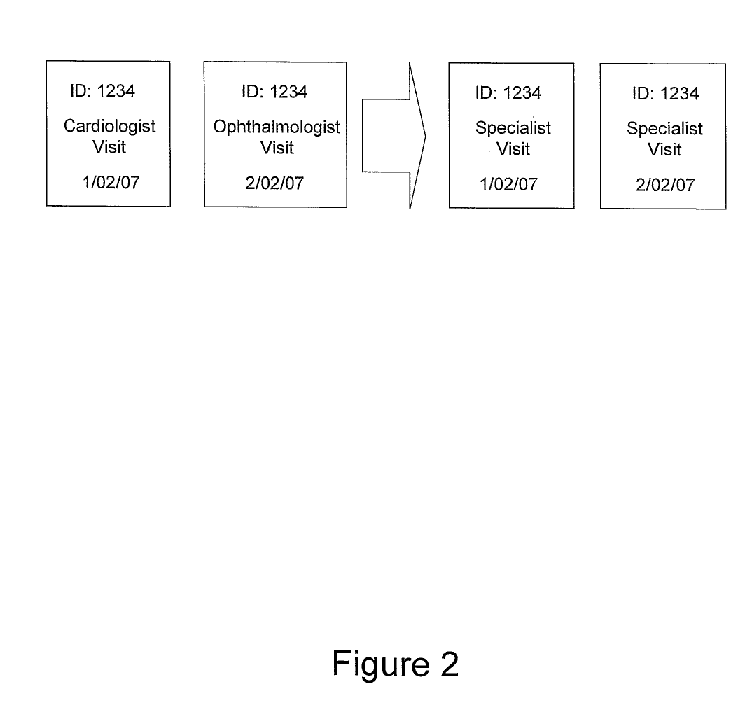

FIG. 2 illustrates an example of classification in action, according to an embodiment of the invention. Two distinct events: cardiologist visit and ophthalmologist visit are classified as a single event: specialist visit.

This representation preserves the events as two distinct events in time, the only change is to the event identifier. Thus, the original events attributes are preserved in this representation. In addition, the original event identifier is represented as an additional attribute to the classified event.

Categorization—a base event is categorized based on one or more attribute values into specific categories. For example: a base event that describes a blood pressure measurement of a patient can be categorized as low, normal, or high blood pressure according to the measurement. The categorization operation is flexible, and enables the organization to define the operation according to its policies, e.g., one organization may choose to define normal blood pressure to be as long as the systolic blood pressure will not exceed 130, while another may choose to define the blood pressure level to be normal as long as the systolic blood pressure does not exceed 120. Moreover, the system allows for personalization, i.e., it is possible to have a different categorization mapping for each patient based on its medical condition (or other factors), e.g., the blood pressure of a patient that is not diagnosed as a diabetic patient will be categorized as normal as long as the systolic blood pressure does not exceed 120, while if the patient is diagnosed as diabetic, her blood pressure will be categorized as normal as long as the systolic blood pressure does not exceed 130.

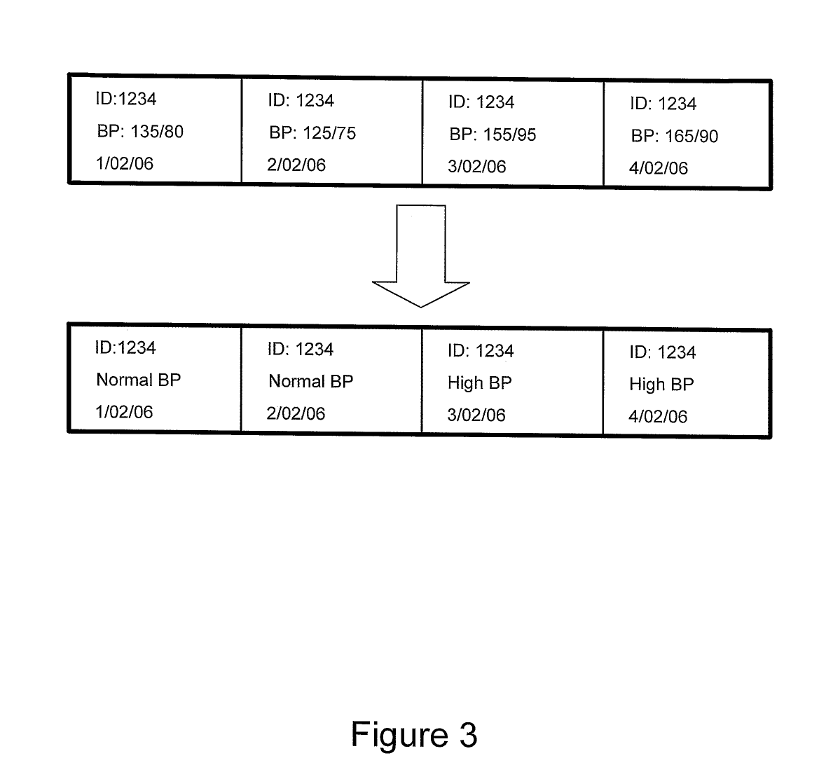

FIG. 3 illustrates a categorization, according to an embodiment of the invention. The categorization of FIG. 3 demonstrates how blood pressure events are categorized into two groups based on the blood pressure measurement. If the blood pressure measured is less than 140/90, then the event is categorized as Normal BP, otherwise, it is categorized as High BP. FIG. 3 depicts four events that are mapped into Normal and High BP events according to the value of the blood pressure attribute.

Comparison—an event (either base or other) is compared to its predecessor event (of the same kind), according to specific comparison rules involving their identifications and/or attributes, to establish whether a change has occurred. If the event has no predecessor event (of the same kind) or if the predecessor event occurred too long before the current event, the current event will be designated as a “beginning event” of the same kind.

For example: a current prescription given to a specific patient is compared to the previous prescription. The current event is identified as an identical event to its predecessor (and lays the ground to omit it) if there is no change in either medicine or the dosage prescribed. Otherwise, a new event (“a change in prescription”) is created and is recorded with the timestamp of the current event.

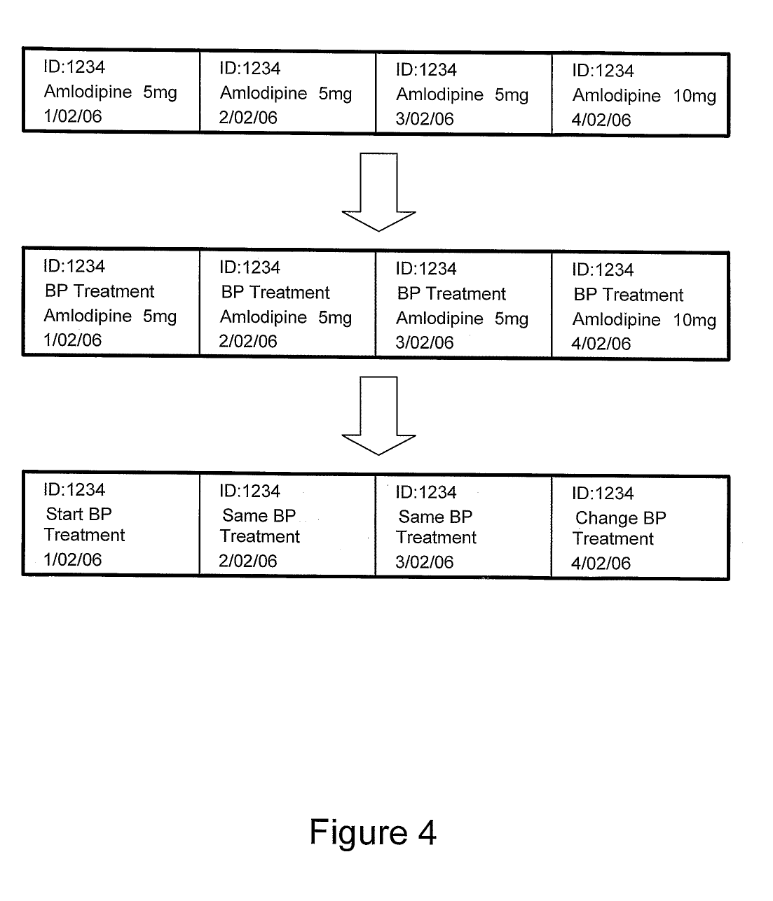

FIG. 4 illustrates a comparison, according to an embodiment of the invention. This example shows several cases of comparison in event creation. First, the events related to prescription of blood pressure drugs is mapped into “BP Treatment” events, with the drug prescribed and its dosage appear as attributes of that event. Next, each BP Treatment event is compared to its predecessor, using the attributes as a key to the decision as to the character of the new event created.

In the example of FIG. 4, the system compares the event: “BP Treatment, Amlodipine 5 mg” on Jan. 2, 2006 to previous events of BP Treatment event and finds that none has been prescribed before. Thus, it designates the event as: “Start BP Treatment.” The next BP Treatment event (“BP Treatment, Amlodipine 5 mg” on Feb. 2, 2006) is compared to its predecessor, and as the attributes are the same, it is mapped into “Same BP Treatment” event. This procedure repeats itself for the next event. When the system recognizes the fourth event (“BP Treatment, Amlodipine 10 mg” on Apr. 2, 2006), it compares it to its predecessor event to find out that the treatment attributes are not the same, hence it maps the event into a “Change BP Treatment”.

Merging—two or more events (base or other) can be merged into a single event based on specific merging rules. For example, consecutive visits to a general practitioner can be merged into a single event, as long as the patient is not visiting other doctors. Categorized events of normal blood pressure can be merged into a single event of normal blood pressure as long as no other kind of blood pressure event is recorded (i.e., low or high blood pressure) for this patient.

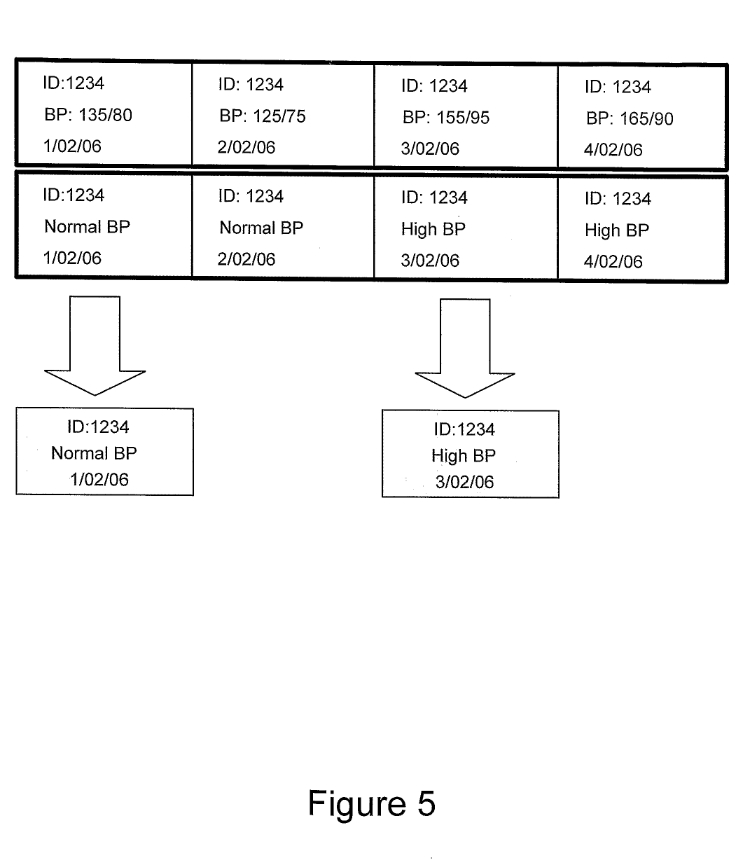

FIG. 5 illustrates merging, according to an embodiment of the invention. The merging rules for Blood Pressure Level events are such that events are omitted as long as there is no change in the blood pressure level (see Categorization, above). In the example depicted in the figure, Blood Pressure Measurement events are categorized to Normal and High BP events (see above). Each of these events is then compared with its predecessor. If the two events are the same, then the two events are merged to a single event that takes the timestamp of the earliest event. This process continues until all Blood Pressure Measurement events are subject to the Merging process. In this example, the two Normal BP and the two High BP events are merged into a single Normal and High BP events, respectively.

Inferred event—an inferred event is not recorded in the raw data and can be created based on manipulations on the events (base or others) according to specific inferring rules. For example: a general practitioner asked a patient to return for a checkup in three months. Once the three months have passed and no visit to the general practitioner is recorded, a new inferred event, “no compliance,” is generated. Another example may be an event of beginning or ending of medicine administration. Assume the data has records of several events of administrating a medicine (e.g., a chronic patient that receives the same drug for years). The first time the medicine is prescribed the system will analyze the data, figuring out this is the first time this medicine has been administered. The system will then generate an inferred event of beginning treatment (with attributes related to the exact medicine and dosage). Similarly, the system can infer when the patient has stopped receiving the medicine, and generate an end of treatment event.

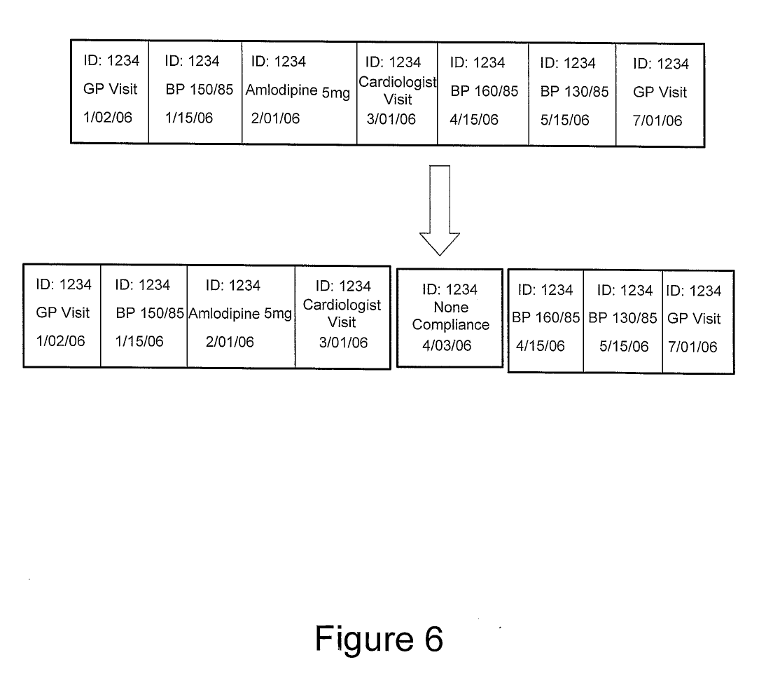

FIG. 6 illustrates an inferred event, according to an embodiment of the invention. This example depicts an example of an inferred event of “None Compliance.” The Actor visited a GP and should return to a checkup within three months. The rules governing the compliance are either described as an attribute of the GP Visit event, or provided elsewhere in a table. Thus, the system knows to expect a GP Visit event within a certain time window. Once this period has passed, and the event has not occurred, the system inserts a new event, in this case, it is a “None Compliance” event with the corresponding timestamp of Apr. 3, 2006.

Please note that the order by which events are manipulated may affect the resulting events (e.g., the events would be different if merging happens before comparison or vice versa). In these cases, manipulation order should also be defined.

Please note that although the manipulated events can be regarded as a compression of the raw data, the information recorded in the raw data is not lost, but can be accessed by request from the manipulated event.

Filtered Events—Some events, although recorded in the raw data, are not relevant to event sequence the system strives to create, and they are filtered, and are not included in the sequence.

Dealing with outliers—some events may occur for a short duration or represent an error and thus may not be medically interesting. These events may be considered as outliers, and users may want the system to filter them out. Therefore, the software includes mechanisms to identify and filter outliers. The process of identifying outliers should happen before the merging process to allow an accurate merged record to appear, not including the outlier event. One method for identifying outliers involves defining a minimum period required for an event to be active to prevent the event from being filtered. Two flavors of this process are described below.

Several processed events may be generated from the same categorization rule, for example, the same categorization rule converts blood pressure measurements (base events) into two events of normal and high levels of blood pressure (processed events). Consider a situation where a patient has the following processed events: Jan. 1, 2007—Normal blood pressure; Jan. 2, 2007—Normal blood pressure; 23/02/2007—High blood pressure; and Jan. 3, 2007—Normal blood pressure. In this case, the high blood pressure event should be filtered because it does not represent the normal situation of the patient and it may be attributed to a bad measurement. In this case, a minimum period (e.g. of 15 days) is defined for a change in the blood pressure level to be recorded in the SEBA processed events. In this case, the high blood pressure event can be filtered because it occurred for a short period. Needless to say that if a merging process occurs, then all the events of normal blood pressure will be merged into a single event after the outlier event is filtered from the record.

A gap may occur in patients' medication consumption especially when the prescription medication was consumed and the patient has not received yet a new prescription. In the current model, the system may wrongly identify this event as a stop to the medical treatment. To prevent this from happening, a time window can be defined by which medical treatment is not considered to be stopped if the same medication was continued to be consumed within that window.

Another method to define outliers is to allow for a number of events, X, out of a total of Y processed event generated from the same categorization rule to be different from the rest. These X events will be redeemed as outliers and will be filtered.

Referring to event sequences as implemented according to different embodiments of the invention. Each actor is associated with a series of events in time. The different events that occur to an actor are ordered chronologically, and create a sequence of events that the actor undergoes.

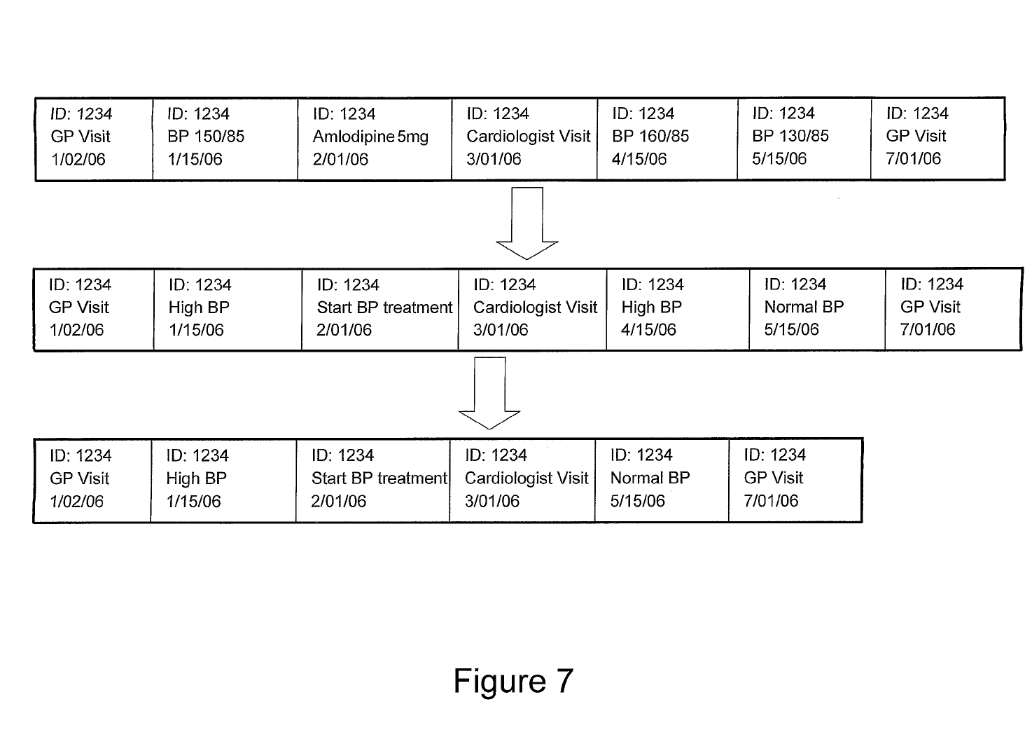

FIG. 7 illustrates an event sequence, according to an embodiment of the invention. This example depicts the transition of the raw data into an event sequence. First, all events related to a specific actor are grouped to a sequence ordered in time. Then, the system applies the classification, categorization, comparison, merger, filter, and inferred events operations (based on the corresponding rules assigned to this system) on that sequence. The result is an event sequence that provides a concise description of what the actor undergoes.

Referring to measures an implemented according to different embodiments of the invention, A measure is an attribute (generated or otherwise) that is associated with a specific time and a specific actor. A measure can be generated from one or more of the following building blocks:
a. Base events (either the event itself or an attribute associated with the event)
b. Processed events (either the event itself or an attribute associated with the event)
c. Measure events (either the event itself or an attribute associated with the event)

A measure event is generated when a specific (defined) condition on base and/or processed events occurs. Each one of the measure building blocks (i.e., base, processed, and measure events) is associated with a value (that may change over time). A measure function maps the values associated with a specific measure building blocks into a measure value. This value represents the value associated with the measure. The measure value relates to a single actor and may change over time.

Referring to measure events, measure event is generated when a specific condition on one or more base, processed, or other measure events is met. This condition may be simple (e.g., an occurrence of a specific event), but may also describe a certain sequence of events, and thus include any combination of rules that act upon the events. An example of a set of rules that act upon the sequence of events is now provided.

To provide a tighter description of a sequence, the concepts of anchors, conditions between anchors, and time limits are provided. An anchor is a placeholder for one or more events. The anchor is redeemed as true when one or more of these events occur in a specific sequence. Anchors are defined in a specific order, and as a result, a sequence of anchors defines a condition on the sequence of events. For example, it can be required to describe a measure event when a patient undergoes a blood test after visiting the family doctor. To define this measure event two anchors will be used: one with the events of a visit to a family doctor or a diabetic doctor (anchor A) and the other is a patient undergoes a blood test (anchor B). A sequence of anchors is defined such that anchor A happens before anchor B. A measure event will be generated every time the condition defined by the anchors is met, that is, whenever a patient visits either the family doctor or the diabetic doctor and after that event, undergoes a blood test. Please note that one or more measure events may be generated for each patient.

To provide a tighter definition on the condition that defines a sequence, constraints are added on the definition that generated a measure event. Two of these constraints are conditions between anchors and time windows. A condition between anchors is a set of events that should or should not occur between specific two anchors. The set of events itself may define an or, and, or not condition. An “or” condition requires the occurrence of one of the events between the two anchors for the condition between the two anchors to be met. The “and” condition requires the occurrence of all the events between the two anchors for the condition between the two anchors to be met. The “not” condition requires that none of the events defined in the condition between the two anchors will occur.

The time window allows defining a minimum or maximum time limit between two anchors for the condition to be met. A maximum time limit condition between anchor A and anchor B requires that anchor B will be met within a specific time window (e.g., 180 days) of anchor A. A minimum time limit condition between anchor A and anchor B requires that anchor B will be met only after a specific time window (e.g., 180 days) of anchor A.

Until now, the description includes measure events that are generated whenever the condition described by the anchors, condition between anchors, and time windows is met. However, measure events can be generated also whenever the condition set upon by the anchors, conditions between anchors, and time windows is not met. Consider, as an example, the following sequence: an event of a severe blood pressure (anchor A), after which a blood pressure holter examination is administrated (anchor B), after which an increase in the dose of blood pressure treatment is administrated (anchor C). Another condition requires that the time between anchor A and C will be limited to 3 months. The system should generate a measure event each time the condition is not met. It is further assumed that the following sequence of events for a specific patient:
a. Jul. 1, 2006 severe blood pressure (anchor A)
b. Sep. 1, 2006 blood pressure holter examination (anchor B)
c. Nov. 1, 2006 increase in blood pressure treatment dose (anchor C)

As one can observe, the condition is not met, because more than 3 months have passed between the severe blood pressure event and the increase in blood pressure treatment dose. A measure event will, therefore, be generated with the date of the first day the condition was not met (Oct. 1, 2006).

In some cases, it is desired to create a repeated measure event whenever a condition is either met or not met. The term repetition is used to describe this type of condition. In the former example, it is desired to generate a measure event repeatedly as long as the condition is not met. Consider the following measure event condition that tracks patients' compliance:
a. Anchor A: severe blood pressure
b. Anchor B: family doctor visit

Another limitation relates to the time gap between anchors—at most 2 months should separate between anchor A and B. A measure event can be repeated, which means that once anchor A occurred, a measure event will be generated every 2 months as long as anchor B has not occurred. As an example, consider the following sequence of events for a specific patient:
a. Jul. 1, 2006 severe blood pressure (anchor A)
b. Dec. 1, 2006 a family doctor visit (anchor B)

Corresponding compliance measure events will be generated on Sep. 1, 2006 and Nov. 1, 2006.

Each measure event can be associated with a value (numerical or otherwise). For example, in the example above, each measure event generated because the patient has not visited the family doctor within 2 months of having a severe blood pressure may be assigned a value of −1. An aggregation of these values over a specific period generates a measure. The measure gives a “grade” as far as a specific patient is concerned. In the example above, where two measure events where generated, the aggregated value of the measure for the period Jul. 1, 2006 and Jan. 1, 2007 is −2 (as two measure events with a value of −1 each have occurred).

This example illustrates a simple aggregation function that simply adds the values associated with the measure event. However, more complicated functions can be used on the values provided by the measure events. In particular, a function can be defined wherein the function allows to reduce the value associated with a measure event over time. In the former example, a reduction of the value of the measure event can be required by 50% if 3 months have passed from the measure event. Under these conditions, on Jan. 1, 2007 and for the period Jul. 1, 2006 to Jan. 1, 2007 measures of 1.5 should be obtained (0.5 from the measure event of Sep. 1, 2007 and 1 from the measure event of Nov. 1, 2007).

Measure events and measures may be ordered in a hierarchy of families and types to help with inheritance (e.g. attributes).

Formally speaking, a measure is a mapping of several measure events (possibly describing different conditions) from different families and type into a number that may change over time.

A measure can be created based on information related to a single event (for example: the cost of an event) or based on specific rules that act upon several events that describe a particular process or any other chain of events (for example: percentage of compliance to specific guidelines).

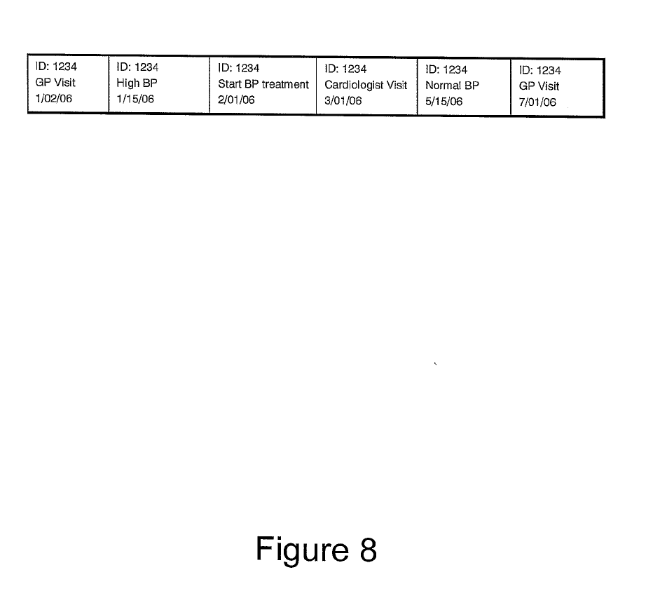

In the following example the use of the cost measure is demonstrated for a single patient (the system can, obviously, aggregate the cost of many patients). FIG. 8 illustrates an event sequence demonstrating the cost measure, according to an embodiment of the invention.

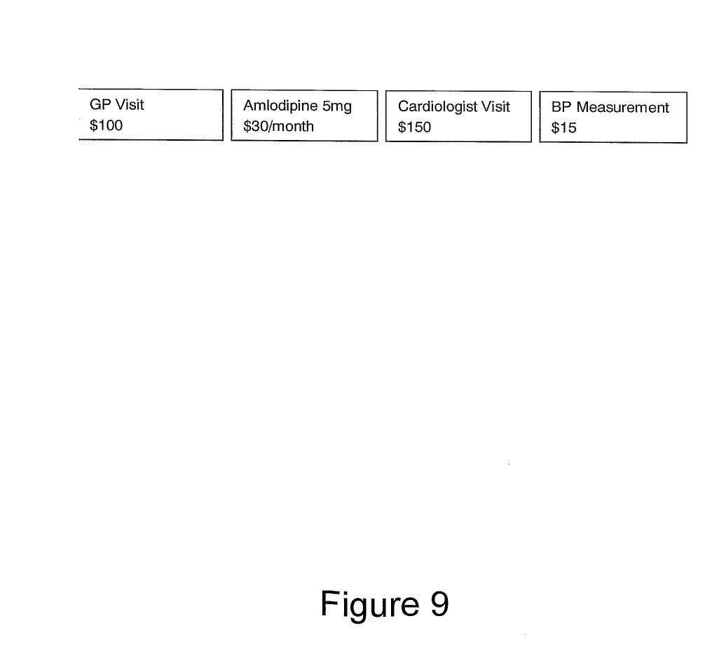

FIG. 9 illustrates the cost attributes of events in the system, according to an embodiment of the invention. Cost attributes are associated with events, as described in FIG. 9. For example, each patient visit to a General Practitioner costs $100, while administrating 5 mg of Amlodipine costs $30 per month.

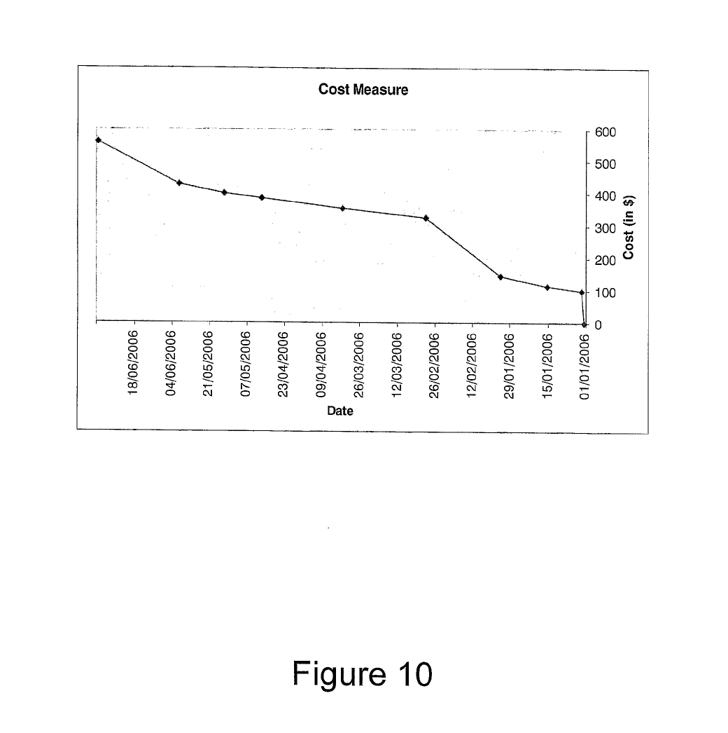

The system can combine these two pieces of information into a cost measure. FIG. 10 illustrates a progression of the cost measure in time, as the patient interacts with the medical provider, according to an embodiment of the invention (in FIG. 10, the cost measure for the patient events described in FIG. 8, and the costs attributes described in FIG. 9)

Measures can also be aggregated over a population. The system can aggregate the measure values of a specific set of population to generate a measure that describes the process a population of patients undergoes. The example of the compliance measure described above can now be re-examined. Recall that the measure events were generated according to the following conditions:

Anchor A: severe blood pressure

Anchor B: family doctor visit

It is also required that at most 2 months are passed between anchor A and anchor B. In a relevant population (i.e. any segment of patients that have severe blood pressure) and for a specific period the method can find patients with measure value of 0, −1, −2, etc. The method aggregates all the measure values from all the patients in the population segment to generate a measure for the whole population. Needless to say that any function can be applied to this number, for example, an average over the population, etc.

Presentation:
a. Measure events are shown as independent events, alongside the processed events (e.g., patient model)
b. Measure events have a value that can be aggregated over time and is associated with each patient. The system can aggregate a group of patient and represent their combined value over time (e.g., analytical model) or combine it for a single patient (e.g., patient model)

Referring to the analysis model implemented in different embodiments of the invention, so far it was described how an event sequence is being generated for each one of the actors. The following includes a description of how an analysis model is generated based on these base event-sequences.

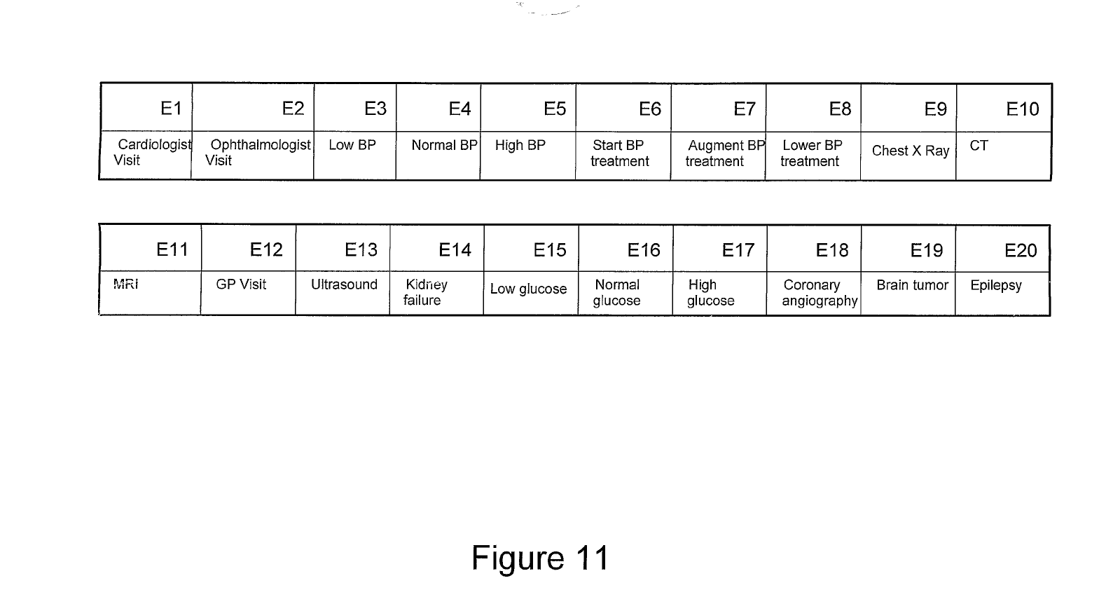

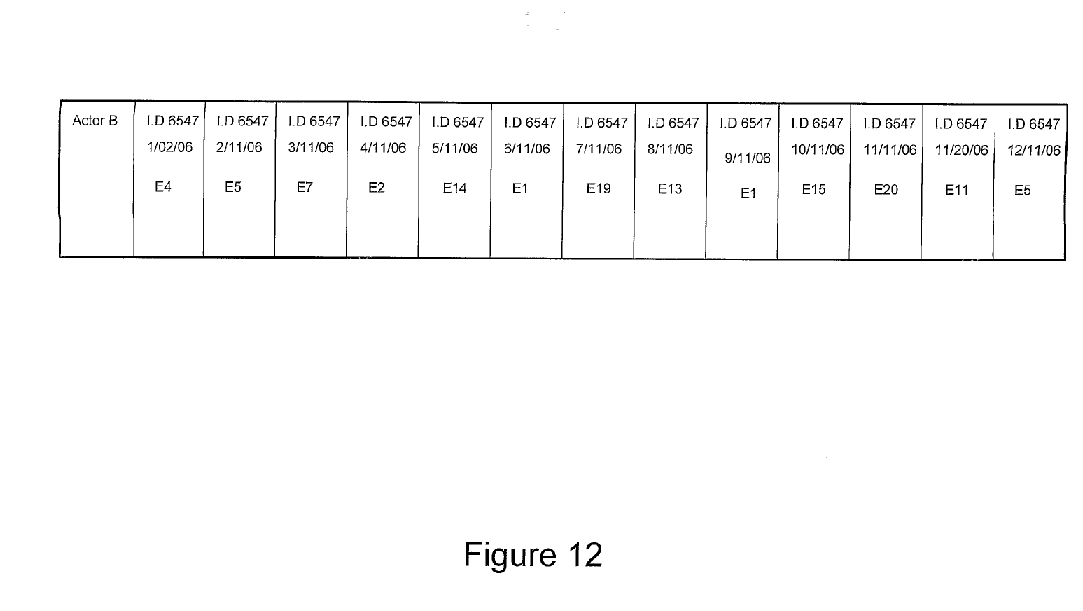

A primary sequence includes all the events in time that each actor undergoes in the system and is recorded in that actor's event-sequence (see FIG. 8 and FIG. 9). The primary sequences of all the actors comprise a primary sequence repository (see FIG. 10). The events that are relevant to the analysis (all or a subset of the events) define the analysis model. The primary sequence may be manipulated according to the analysis model to include only those events that are defined to be part of the analysis model (see FIG. 11, where events E19 and E20 are omitted from the analysis model). Please note that this stage is redundant if all of the recorded events are part of the model. The resulting sequences are aggregated to constitute an analysis sequence repository (see FIG. 12) that includes only those sequences and those events that are relevant to the analysis (according to the analysis model).

FIG. 11 illustrates a list of the events that are created by the system and can appear in the primary sequence, according to an embodiment of the invention. The keys (E1, E2, . . . E20) that designate the event identifier are used throughout the following examples.

FIG. 12 illustrates a primary sequence of Actor B, according to an embodiment of the invention. It is noted that the primary sequence may include any event described in the list of events (see FIG. 8).

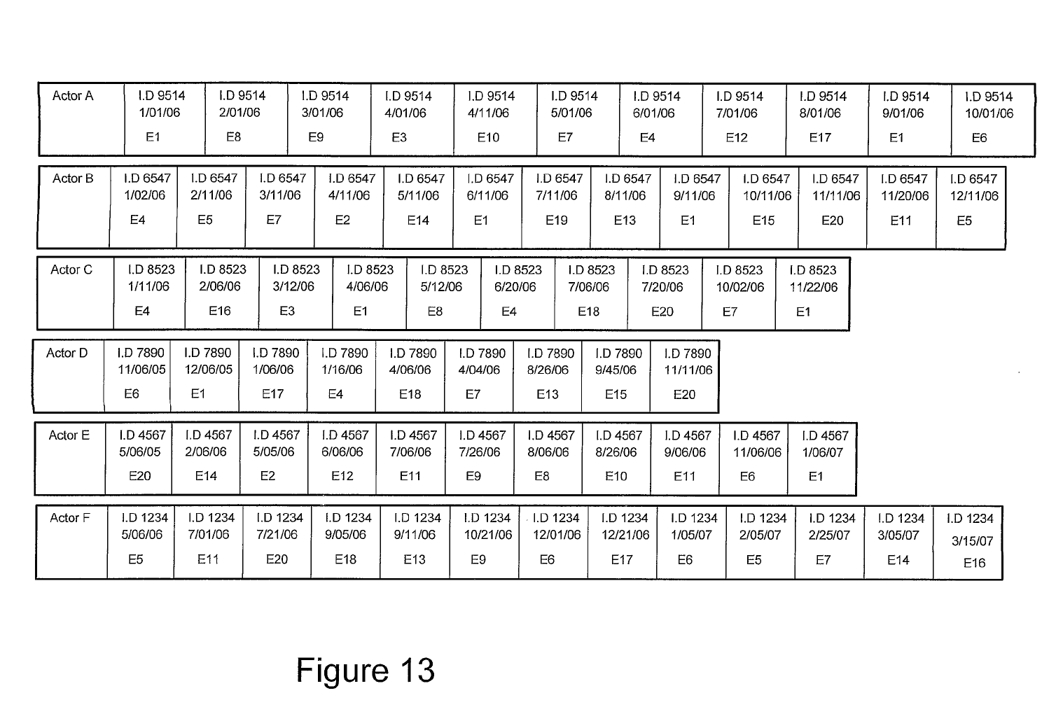

FIG. 13 illustrates a Primary Sequence Repository is an aggregation of the primary sequences of all the actors, according to an embodiment of the invention.

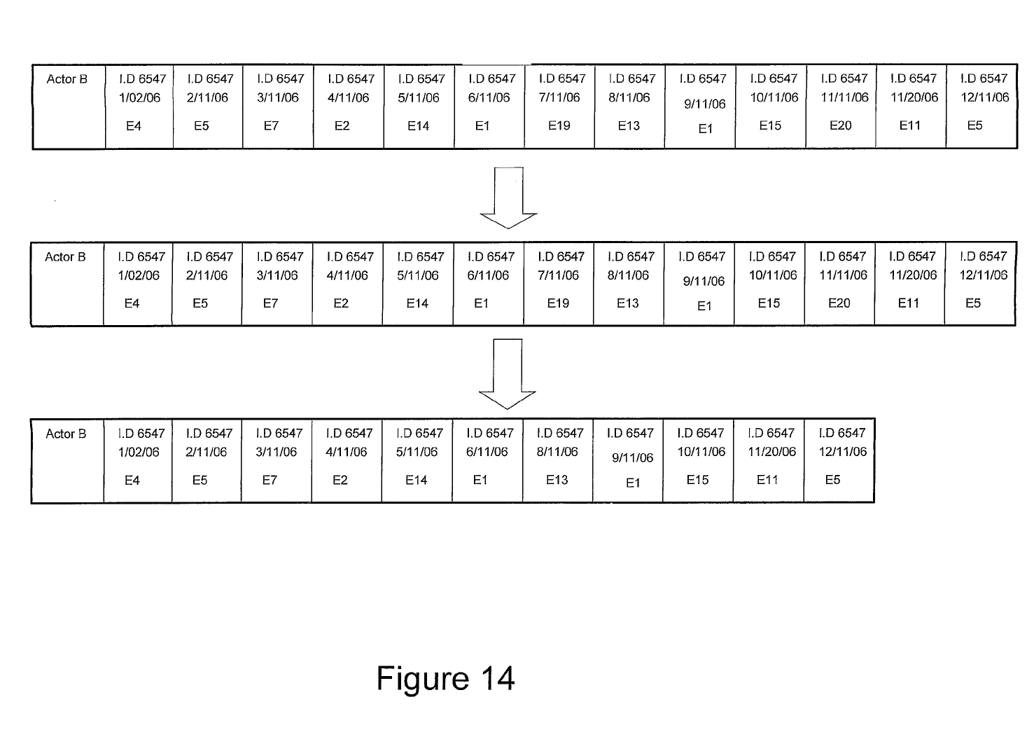

FIG. 14 illustrates a generation of an analysis sequence out of a primary sequence for Actor B, according to an embodiment of the invention. The analysis sequence filters events E19 and E20 of the primary sequence.

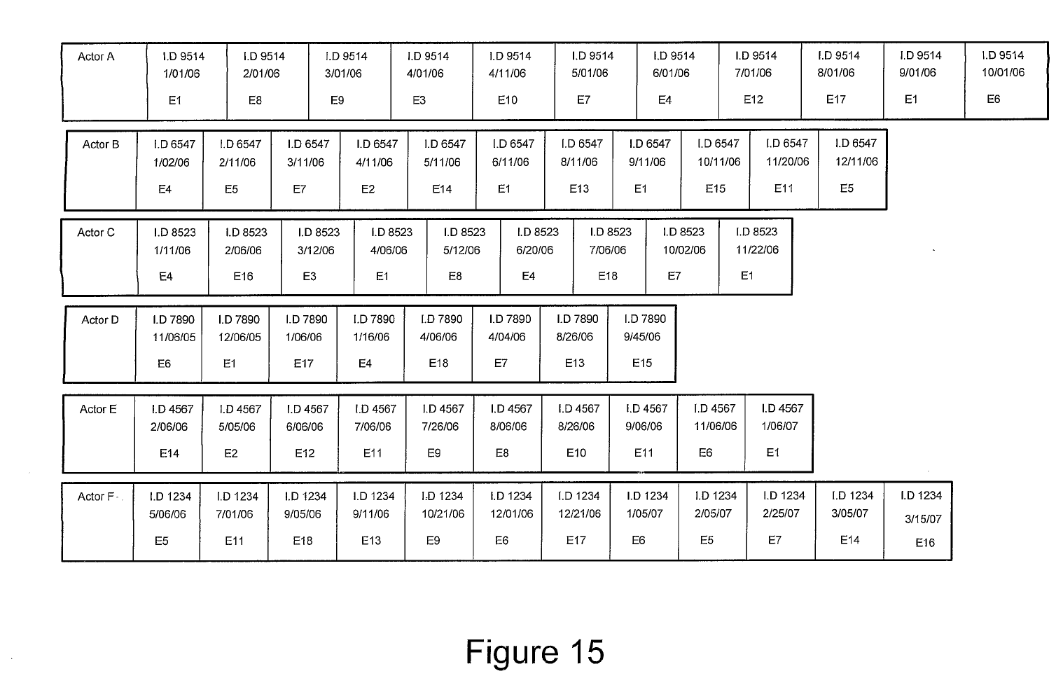

FIG. 15 illustrates an Analysis Sequence Repository is an aggregation of the analysis sequences of all the actors, according to an embodiment of the invention.

The analysis model and/or the aggregated sequences can be further manipulated and mapped to a new analysis model and/or set of sequences according to specific filter parameters. The sequences manipulations may include (among others) the ability to represent a subset of events as a single event that describes this subset (e.g., all events related to neurological complications in diabetic patients would be now represented as a single event that is call: “neurological complications”). The resulting sequence maps each one of the events in the subset to the single event representing this subset. Another manipulation may combine consecutive occurrences of that single event into a single occurrence of that event.

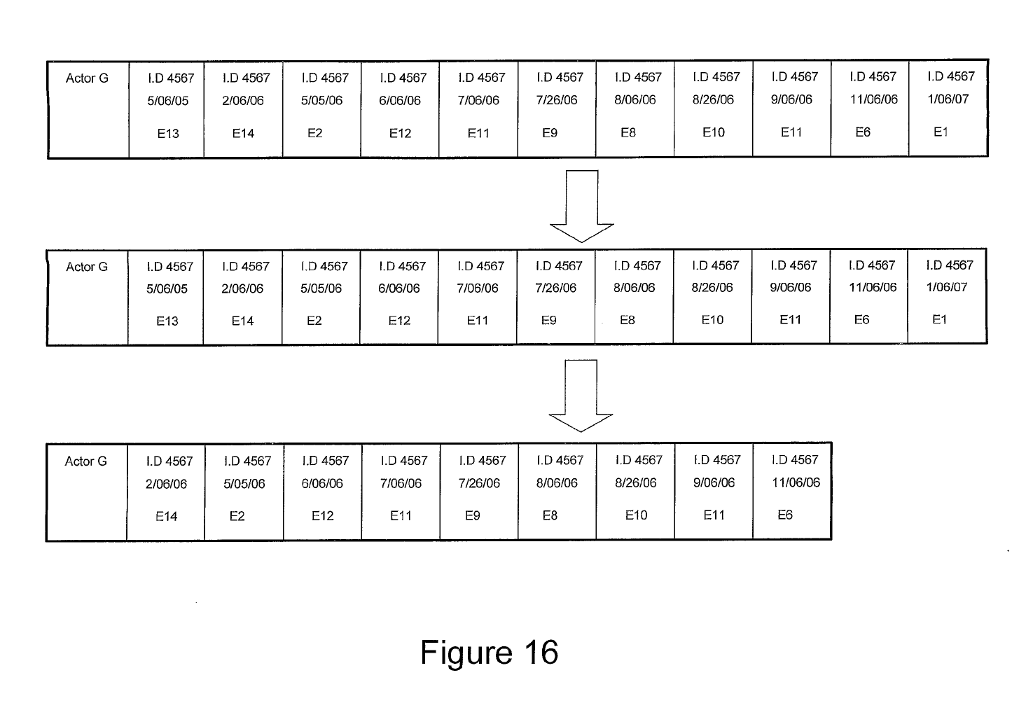

FIG. 16 illustrates an Analysis Model filtered by date, according to an embodiment of the invention, wherein it is noted that the analysis model illustrated in FIG. 16 includes only the events that occurred in the year 2006.

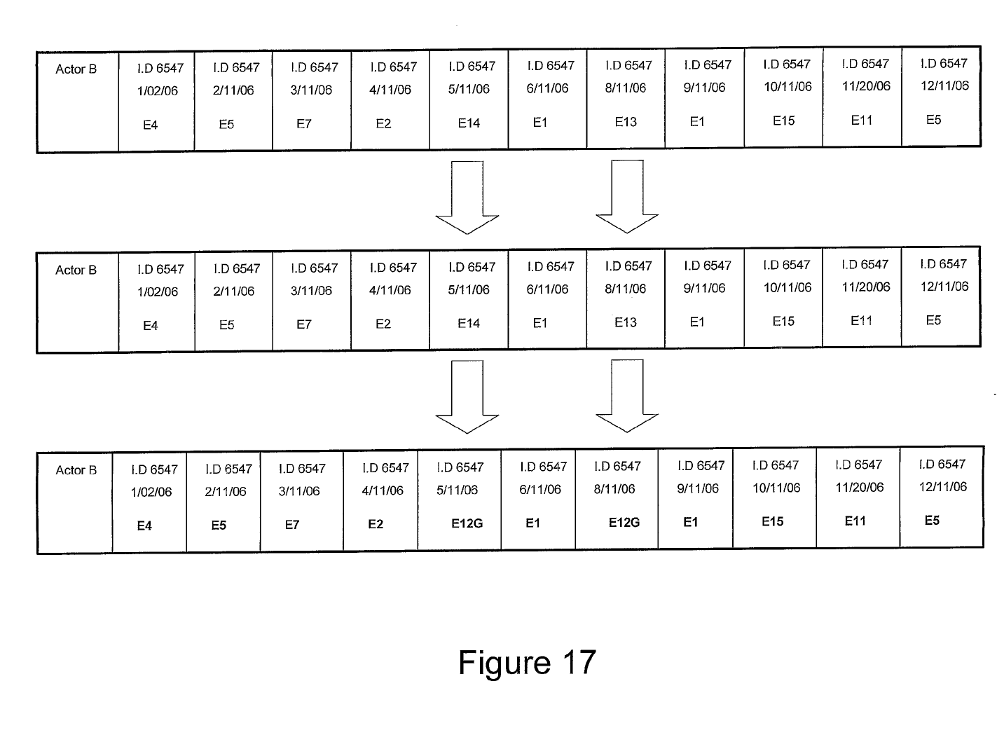

FIG. 17 illustrates events E12, E13, and E14 that are now mapped to event E12G, according to an embodiment of the invention.

These aggregated sequences can be filtered even further to include or exclude entire sequences, subsequences, or isolated events according to filter parameters. Among others, these filter parameters may include one or more of the following filters (or a combination of them):
a. Events by time (e.g., include only those events that occur between Jan. 1, 2007 and Jan. 1, 2008)
b. Sequences that have events in a certain period of time
c. Actors according to attributes associated with them (e.g., demographics)
d. Events according to their events attribute or measures associated with the events (e.g., exclude/include patients who undergo a blood test with hemoglobin level of less than 12.0)
e. Actors who experienced a specific event subsequence (e.g., patients who visited a specialist and then transferred to a CT)
f. Actors according to a measure value associated with them (e.g., patients who their treatment costs more than X amount of dollars).
g. Duration of a subsequence that is part of the whole sequence an actor undergoes

This model allows formulating a convenient language to describe, understand, and analyze the events and processes that all relevant actors undergo in the system and/or organization.

### Queries on Events in the Sequence Repository

The sequence repository stores a list of events ordered by actors and time. A system can query this repository to answer questions about the relationship between actors, events, and time. The queries are performed against the sequence repository that stores the sequences of all of the actors in the system (and not necessarily against a single actor's sequence). The answers may relate to one or more sequences. To follow are examples of queries that can be defined (and answered) by the system:
a. Basic queries that result in a number (or a list of numbers):
   i. How many actors were involved in an event?
   ii. How many times an event occurred (this may include multiple occurrences to the same actor)?
   iii. What are the values of the event attributes? The answer can be characterized as an average, distribution (and/or any other statistical descriptor) of attribute values.
   iv. What is the measure value associated with an occurrence of a specific event? The answer can be given as the sum (and/or any other statistical descriptor, such as, average, standard deviation, etc.) of all measure values associated with the different actors sharing this event.
b. Queries that result in subsequences of events
   i. What was the immediate successor (predecessor) event to (from) a specific event? The answer can be characterized by the number of actors, the number of occurrences, and the average time between the two events.
   ii. What are the subsequent (prior) base (or others) events and/or measures that was lost during the event formation phase?
   iii. Order the event sequences (of length X) that occur before (after) a specific event according to popularity, measures, or other attributes.
   iv. Order all the sequences that occur within a defined period (irrespective of their length) according to popularity, measures, or other attributes.
   v. Which events occurred after (before) X number of events in the subsequences that started (ended) with a specific event?
   vi. Which events are associated with specific attribute or measure values?

### Meta-Events

A meta-event provides with the ability to create a complex pseudo-event out of one or more existing events. The definition and use of meta-events allows formulating more complicated queries.

A meta-event is defined as an occurrence (or absence) of a single event (and/or an attribute value(s) associated with an event) or a logical relationship among multiple event (and/or their attributes) occurrences (operations such as and, or, not, xor, nor, etc. e.g., the occurrence of events A and D or the occurrence of event B, but not the occurrence of event C, see FIG. 15 and FIG. 16).

A multi-meta-event is defined as logical relationship among multiple event (and/or their attributes) occurrences or absences. A logical operation that represents the relationship can include, for example AND, OR, NOT, XOR, NOR, NAND, NXOR and the like. It can indicate a certain combination of events such as the occurrence of events A and D or the occurrence of event B, but not the occurrence of event C, see FIG. 15 and FIG. 16). A multi-meta-event is a sub-set of a meta-event.

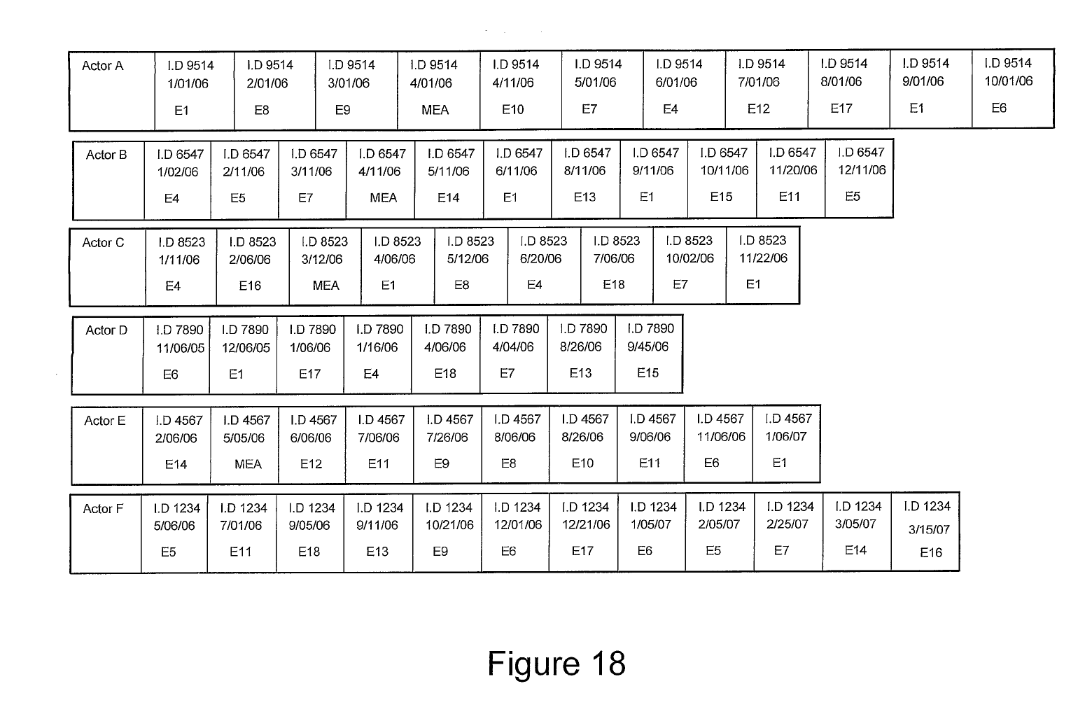

FIG. 18 illustrates a definition of a meta-event, MEA, defined as an occurrence of either event E2 or event E3, according to an embodiment of the invention.

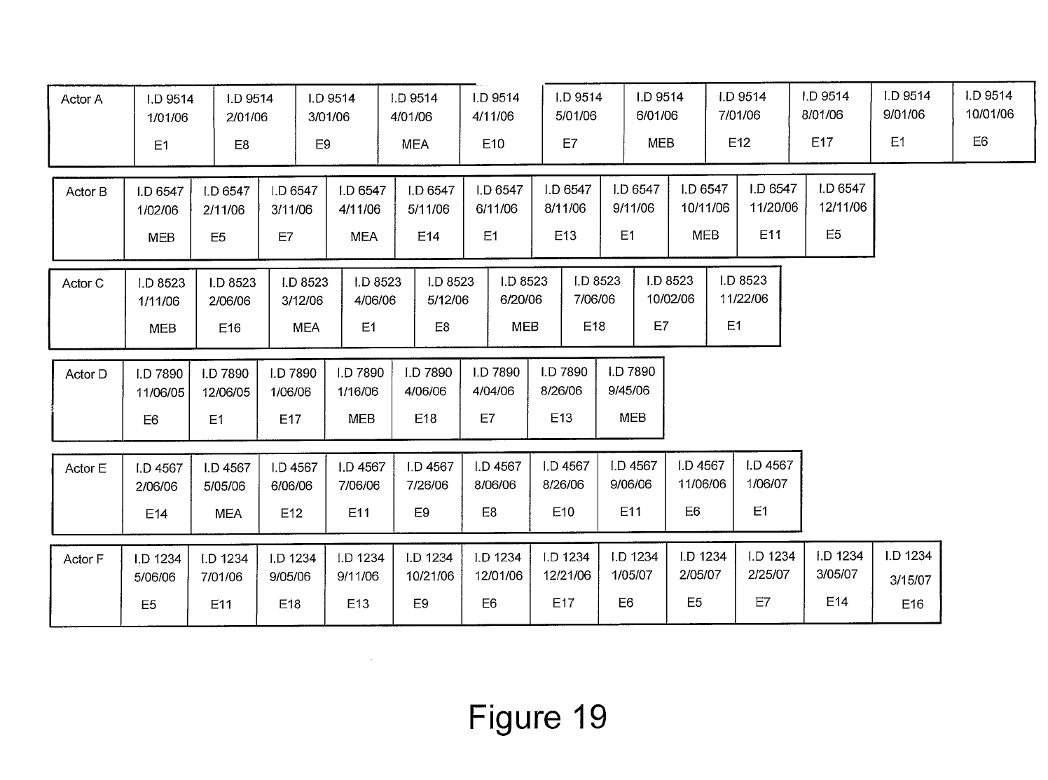

FIG. 19 illustrates a definition of a meta-events MEA (see FIG. 15), and MEB, defined as an occurrence of either event E4 or event E15, according to an embodiment of the invention. The sequences in this example are based on the sequences provided in FIG. 12.

### Queries on Meta-Events

The system allows the user to regard a meta-event as a regular event and perform the event queries discussed above (see: Queries on Events in the Sequence Repository, above) on meta-events. In addition, the system allows the user to define a Sequence of Meta-Events (SME). The SME describes an ordered list of meta-events, which actors can fully or partially follow or not follow at all. Queries on the SME may preserve the actors (and their corresponding sequences) that fully or partially followed the SME, or not followed it at all. In addition, the system creates subgroups of sequences and actors according to the last meta-event in the SME these actors followed.

As mentioned earlier, SME defines an ordered list of meta-events. FIG. 17 provides an example of the SME: MEA→)MEB (look for the occurrence of meta-event MEA preceding meta-event MEB). A query on an SME may be further refined by requiring that specific relationships and/or conditions among consecutive meta-events in this sequence occur. These relationships may define which meta-events occurred (not occurred) between two consecutive meta-events and the time difference allowed between two consecutive meta-events (and/or among multiple meta-events). FIG. 18 shows a definition of a refined SME where the above SME is refined not to allow the occurrence of event E7 within the SME.

An SME query is essentially a condition that tests each sequence in the analysis sequence repository to see whether it fulfills the conditions defined in the SME and the query relationships. If the sequence fulfills these conditions, then that sequence is said to be fully complied with the SME query. As described earlier, sequences may partially comply with the SME, and the system groups the sequences according to the last SME meta-event that was followed.

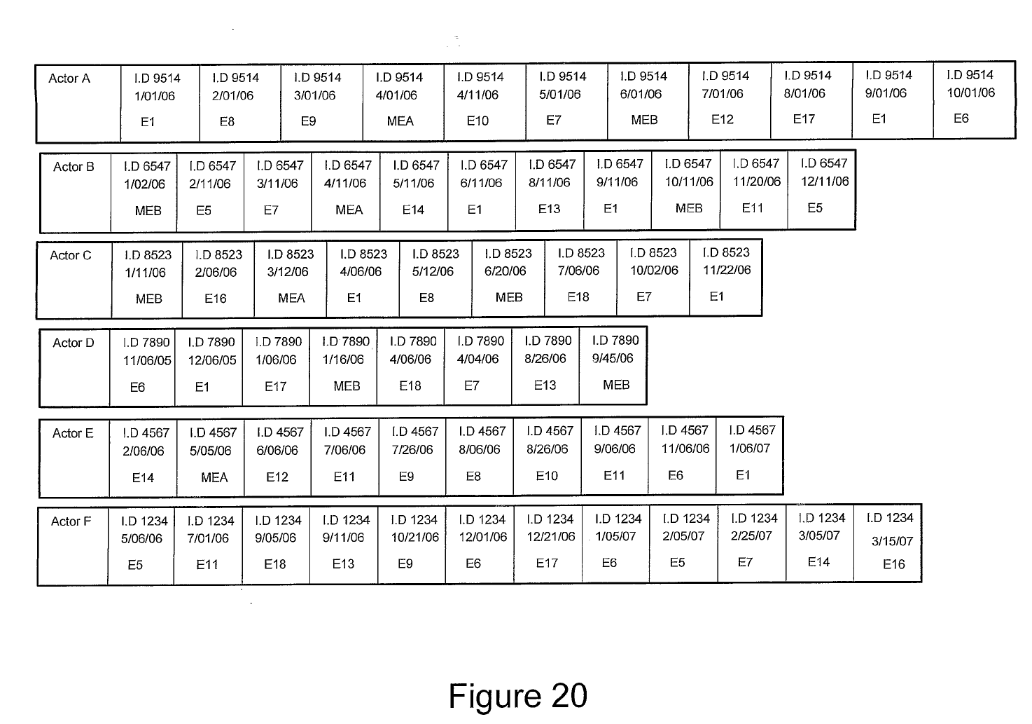

A subset of sequences that fulfill the conditions is defined in the SME and the query relationships. This subset of sequences is referred to as DSS (which stands for Defined Subset of Sequences). FIG. 19 shows the DSS for the query described in FIG. 18. In addition, it is possible to form a subsequence that begins with the first meta-event and ends with the last meta-event in the defined order for each one of the sequences in that subset. These subsequences are referred to as MDS (Meta-event Defined Subsequence). FIG. 20 illustrates the MDS for the query described in FIG. 18, according to an embodiment of the invention.

FIG. 20 illustrates an example of a query that looks for the SME: MEA→MEB. The relevant occurrences are highlighted in yellow. Please note that the query does not include cases where MEA occur without MEB, MEB occur without MEA, or MEB appear before MEA .

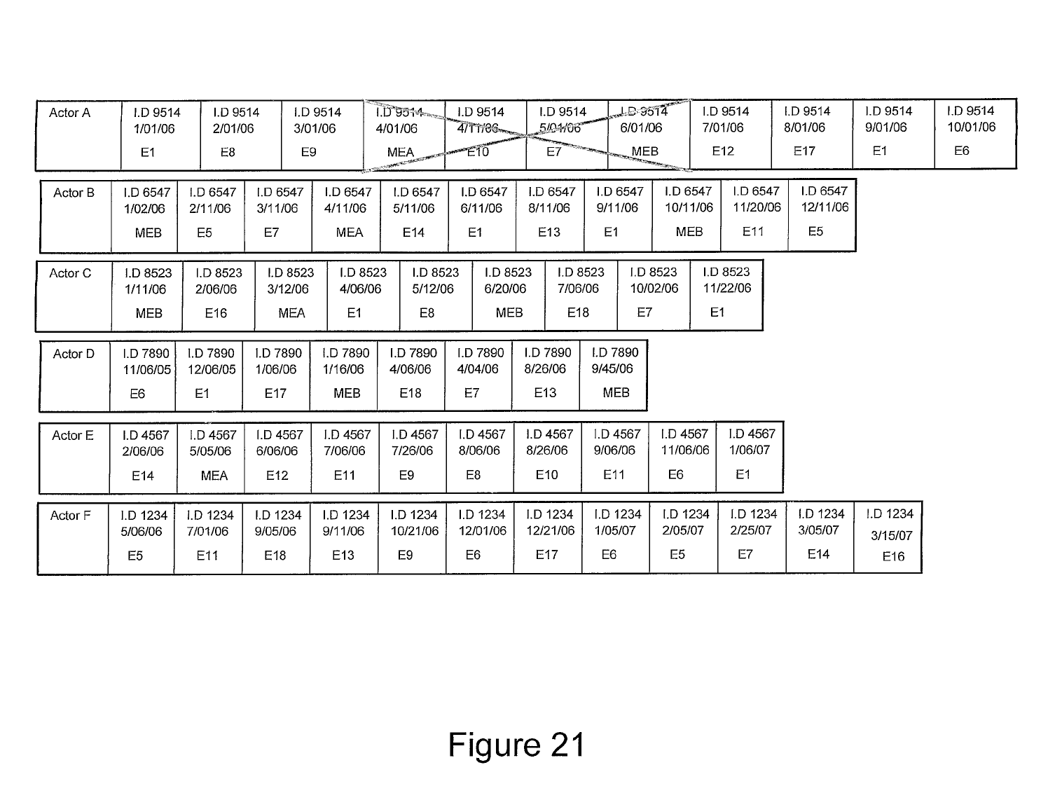

FIG. 21 illustrates an example of a query that looks for the SME: MEA→MEB but does not permit the occurrence of event E7 within the sequence, according to an embodiment of the invention. The relevant occurrences are highlighted in yellow. Please note that Actor A has a sequence MEA→MEB, but does not comply with the condition not to include event E7 within the sequence.

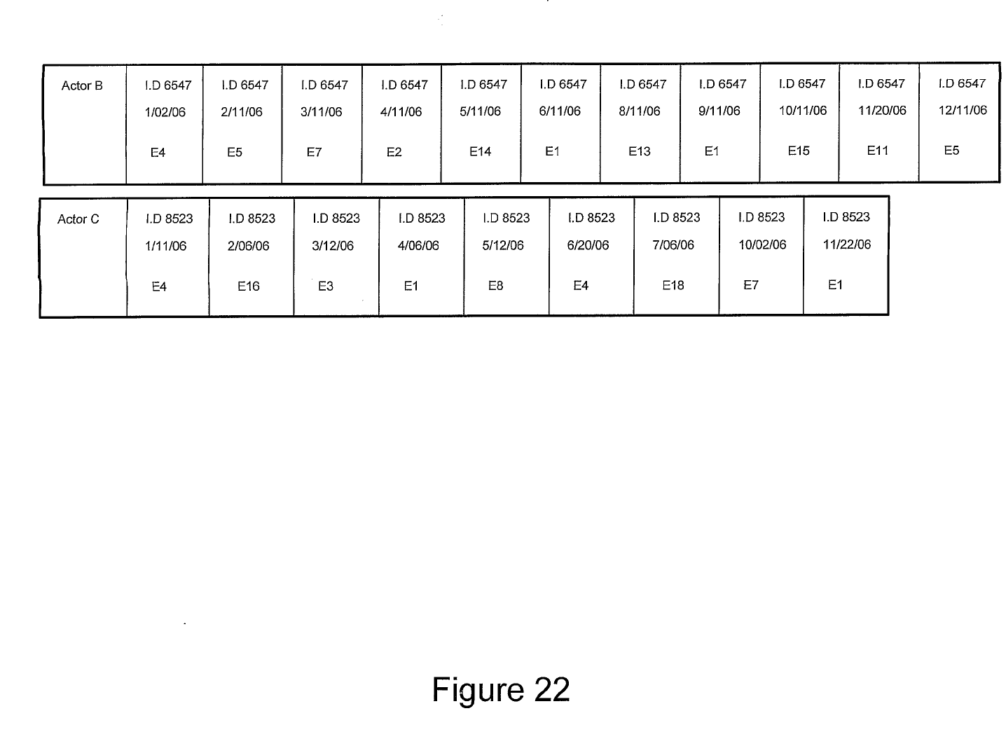

FIG. 22 illustrates a defined Subset of Sequences (DSS) of the query presented in FIG. 18, according to an embodiment of the invention.

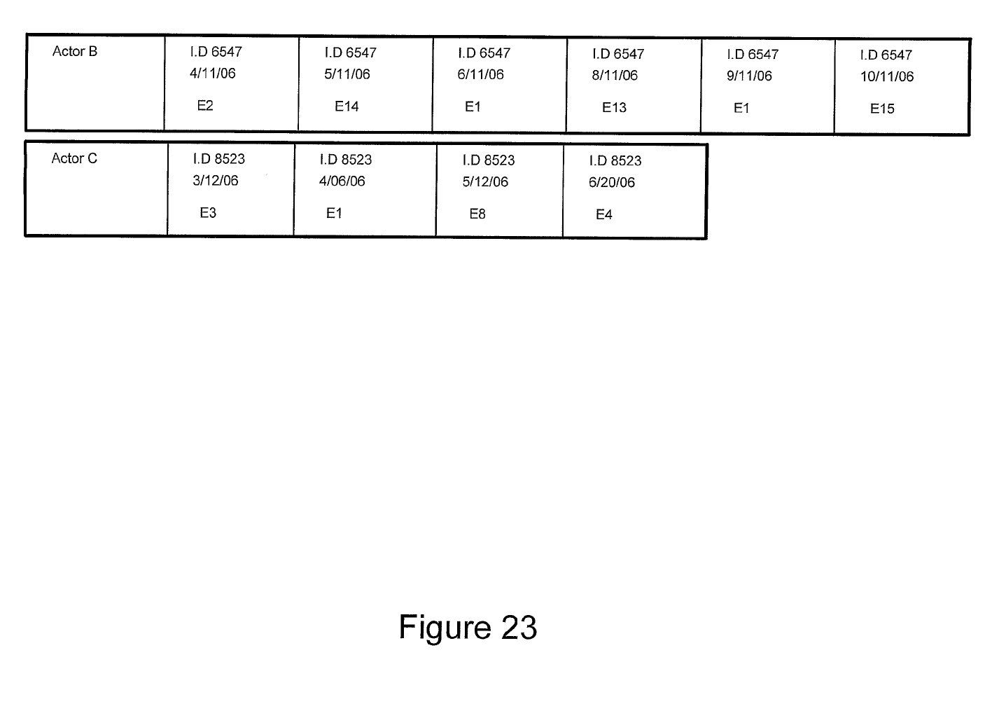

FIG. 23 illustrates a meta-event defined Subsequence (MDS) of the query presented in FIG. 18, according to an embodiment of the invention.

Using this information, the system can characterize the processes that the SME represents and can answer the following questions (among others):
a. Characterize each SME by its attributes and/or measures (if present), by the number of its actors and/or by the number of the occurrences of the MDS (that is related to the SME) in the DSS. The answer can be given as an average or distribution of attribute values. In the example provided in FIG. 18, the query occurs twice on two actors.
b. What is the average time between two meta-events?
c. Order all the events (and/or sequences) that occurred between two consecutive meta-events.
d. What was the immediate successor (predecessor) event to (from) a specific meta-event? The answer can be characterized, among others, by the number of actors, the number of occurrences, and the average time between the event and the meta-event.
e. Compare between two DSS. The answer can be characterized, among others, as an average or distribution of attribute values, measures, and/or events.
f. Re-investigate a MDS—using the MDS as a filter to show the event sequences of the actors that perform the MDS and uses them as a new analysis model.
g. Creating a new analysis sequence repository that includes only the

MDS events, or only the events that occur before the MDS, or only the events that occur after the MDS.

### Mapping of Sequence Repository to a Visual Medium

A visual medium is used to reflect the information stored in the analysis sequence repository and to enable users to understand and hone in the information that is relevant to their questions. The defined model (all of it, or part of it that is relevant to the user's questions) is presented in the visual medium in the form of events on a screen. The visual model defines the events, and clusters the events according to different criteria (e.g., the medical procedures that specific events belong to). The events are then arranged on the screen in specific areas, according to the clusters defined in the visual model (see FIG. 21 and FIG. 22). Please note, that this description does not prohibit users from changing the pre-defined clustering on the fly while interacting with the visual medium. In this case, the visual representation of the model will reflect the new user-created cluster definition.

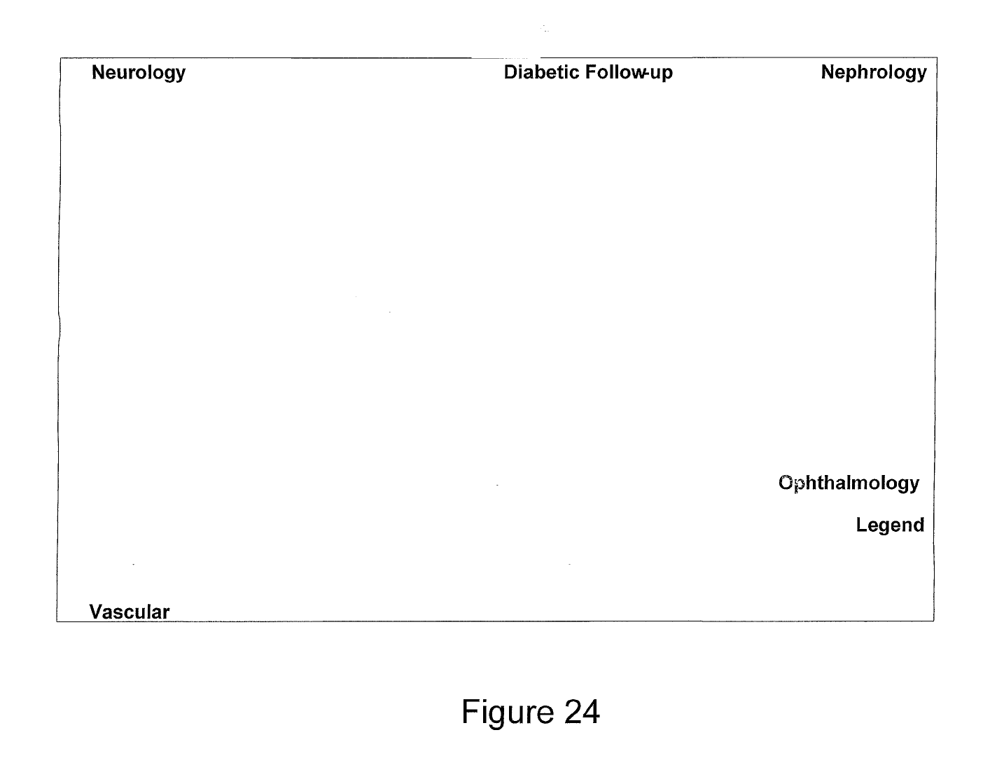

FIG. 24 illustrates the visual medium that is divided into areas according to the application logic, according to an embodiment of the invention. In this example, the visual medium displays events related to diabetic treatment. The center area is designed to display events related to Diabetic Follow-up, while the side areas are designed to display events related to the most common complications of diabetic patients.

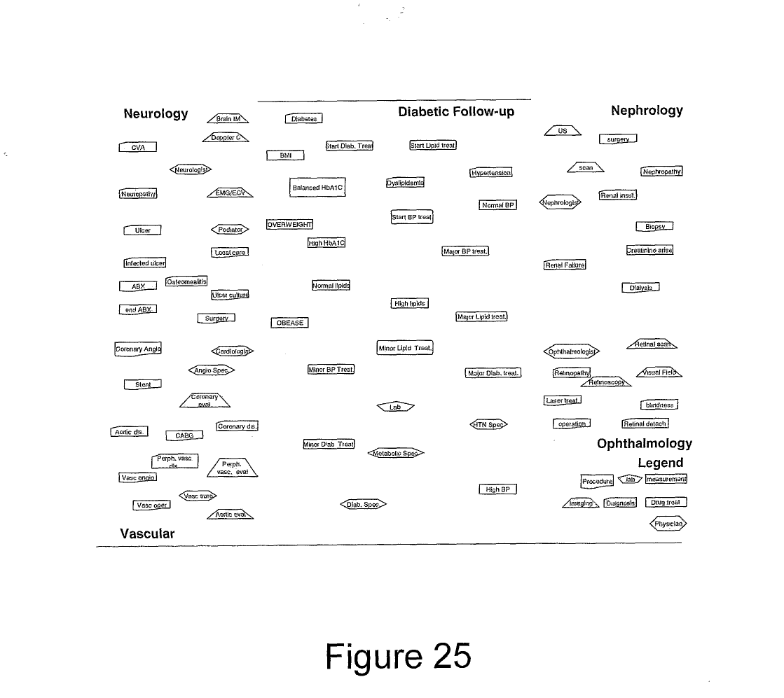

FIG. 25 illustrates the visual medium that displays events related to diabetic treatment, according to an embodiment of the invention. The events are distributed among the various display areas according to their classification.

In addition to excluding information that is irrelevant to the user in terms of type (that is, showing on the screen only a subset of the defined events), the user can exclude events occurrences that are irrelevant in terms of their time (i.e., events that occurred in a time interval that is irrelevant to the user). When reflecting the event sequences on the visual model, the system filters all events occurrences that do not fall within a pre-defined time-interval. Please note that the time-interval does not have to be consecutive, and may be a combination of multiple time-intervals. Another way to look at these definitions is to view the relevant data as a reflection of the original sequence repository that includes only relevant events and their occurrences within the selected time-interval (see FIG. 23).

The visual representation allows users to focus on specific areas on the screen, leaving out from the view areas they are not interested in (see FIG. 25). In addition, it is possible to represent several events as a single event-set, e.g., all model events related to vascular complications in diabetic patients can be represented on the screen by a single entity called event-set. Any record of an event that is part of the events that constitute the event-set is interpreted as happening to the event-set. Thus, in our example, any event related to vascular complications in diabetic patients is represented as part of the new event-set “vascular complications”. Once the event-set is shown to the user, the original events that constitute the event-set are not shown to the user. In addition, all other information presented on the screen (e.g., statistics, sequence information, see FIG. 24 below) reflects this change. Another way to explain this is that the screen will show the same information it would have shown the model was defined such that this event-set is a complex event. The user can then toggle between the two representations (i.e., “close” the representation when only the event set is shown and “open” the representation when all the events that constitute the event-set are shown) and the screen reflects the information according to the representation selected. The user can define multiple event-sets at the same time and choose to “open” only a subset of these event-sets.

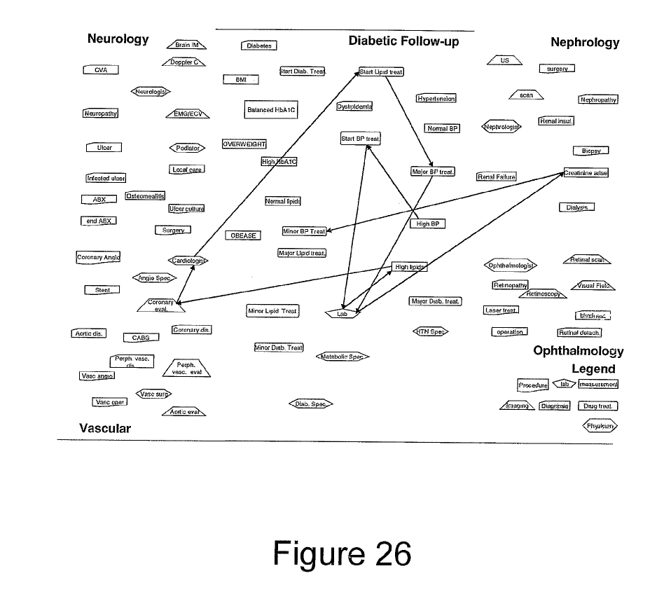

FIG. 26 illustrates the visual medium that depicts a sequence experienced by some patients, according to an embodiment of the invention. The arrows describe the sequence order. Thus, this sequence begins with “High BP” and ends with “Minor BP treatment”, following the arrows.

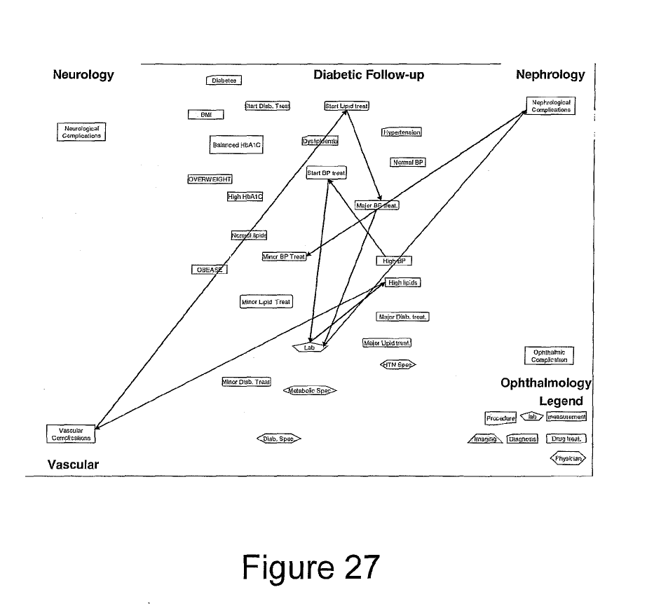

FIG. 27 illustrates the same sequence depicted in FIG. 23, according to an embodiment of the invention; however, the visual medium in this figure represents each one of the complications as a single event-set. The sequence is altered to reflect this change so that all the consecutive events related to each one of the complications are collapsed into a single event that is mapped to the single event-set.

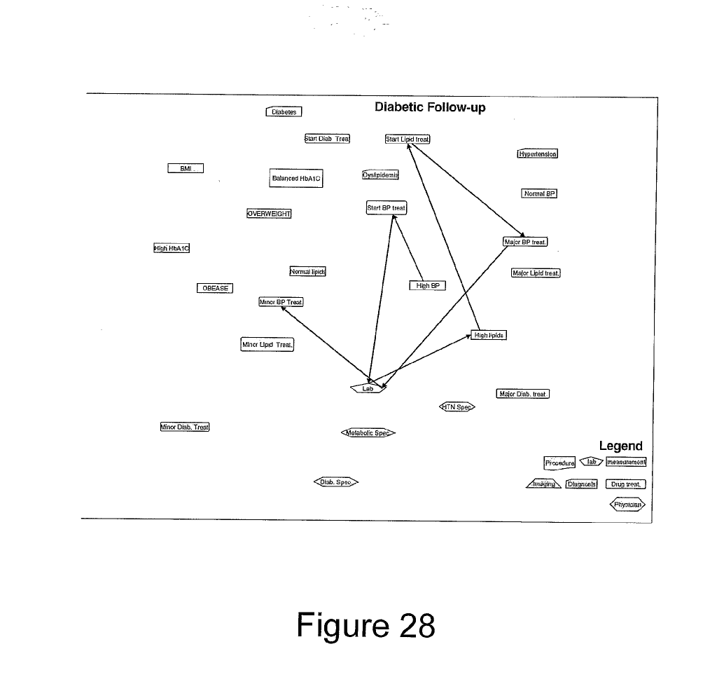

FIG. 28 illustrates the same sequence depicted in FIG. 23, according to an embodiment of the invention; however, this time the visual medium represents only the diabetic follow-up events, omitting the rest of the events. The sequence is altered to reflect this change by omitting all the events that are not included in visual medium from the sequence.

### Implementation Description

The method can be divided into two main parts: (i) Event Sequence Repository generation; and (ii) Definition, execution, and presentation of queries and their results.

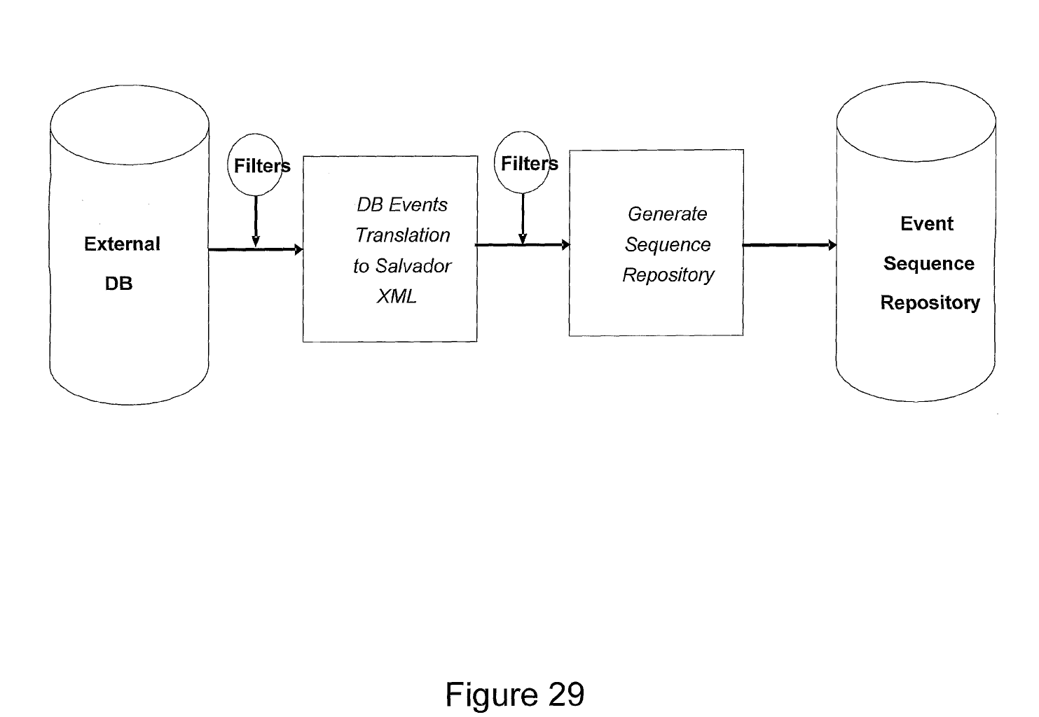

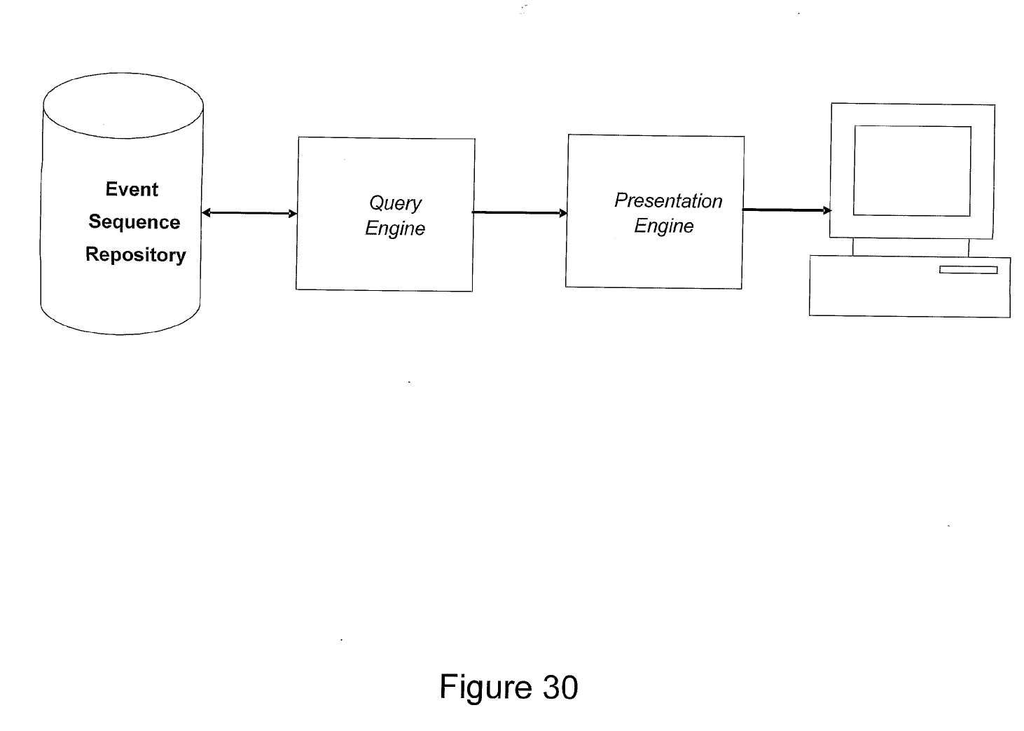

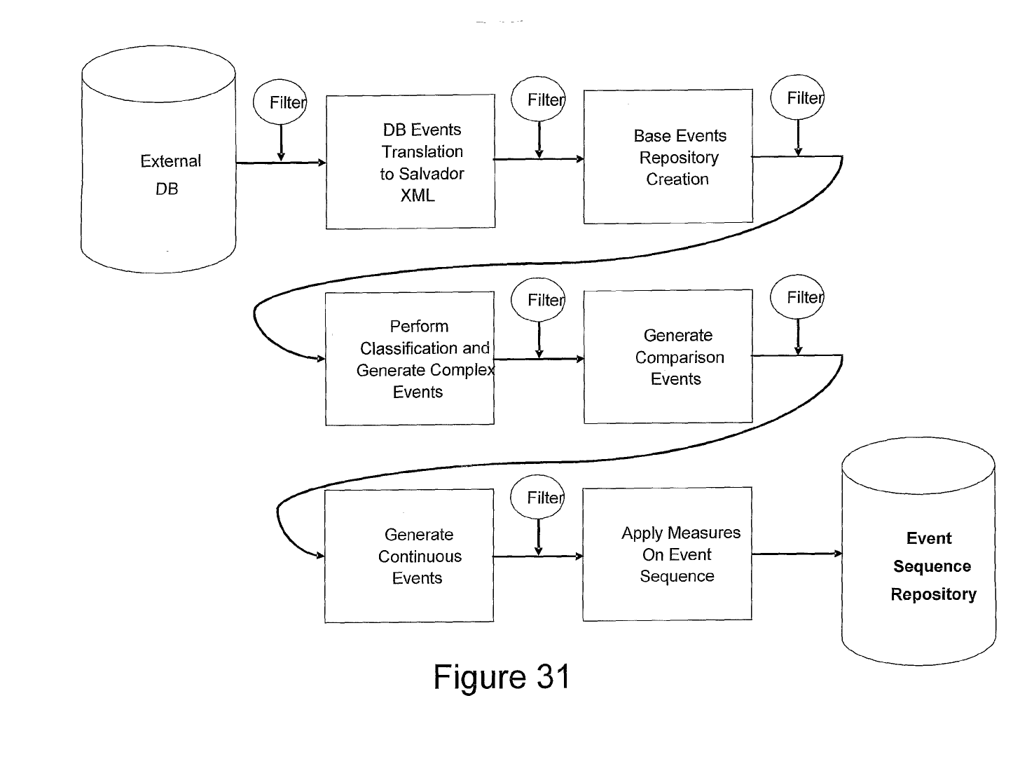

FIG. 29 illustrates a workflow that generates the event sequence repository (ESR), according to an embodiment of the invention. Data stored in external databases is read and transformed to A predefined representation. During this stage, database information is translated to base events that are stored in a specific format. These events are then sequenced (based on time and actor ID). The initial sequences are further processed to include more complex events (as mentioned above in the section that describes the events) and put in an ESR. FIG. 30 is a block diagram of the Query and Presentation Layers. FIG. 31 shows a detailed description of a possible ESR generation workflow.

Once the ESR is created, users can query it. FIG. 30 presents a description of this part of the software, according to an embodiment of the invention. The Query Engine queries the ESR for the occurrences of specific sequences in the repository, as described above. The results may update the ESR in case the ESR caches query results. The results are then processed by the Presentation Engine, and sent for the viewer to interact with.

FIG. 31 illustrates a detailed description of a possible process for generating Event Sequence Repository from existing databases, where the raw information is stored, according to an embodiment of the invention.

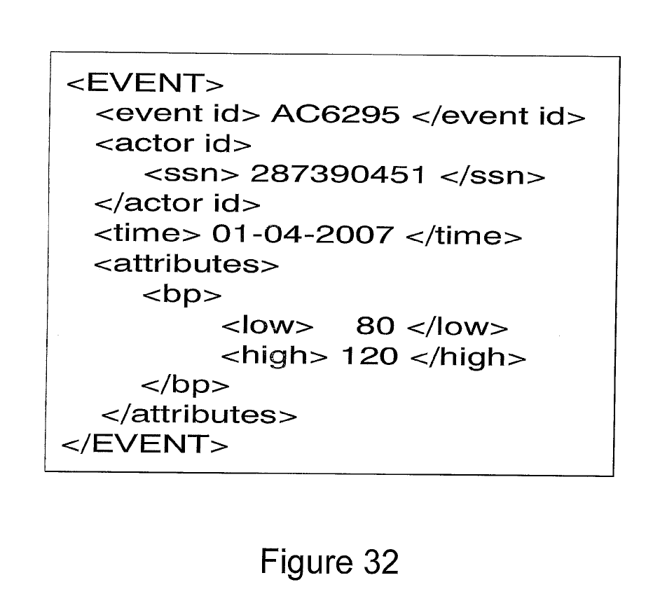

FIG. 31 Provides a detailed description of a possible process for populating the Event Sequence Repository from existing databases, where the raw information is stored. First, the database events are translated to The predefined XML (e.g., FIG. 32 that is an EML representation of a single event, according to an embodiment of the invention). Then, a base event repository is created by reading the events that are stored at The predefined XML and arranging them by time and actor ID. Once the base event repository is created, the system can then process the events. At first, events are classified and complex events are created. Then, comparison events are created. Then, continuous events are created, and finally, measures are applied to form the repository. Please note that information is not lost in the process, as the repository preserves the base events that were the basis to each of the operations: classification, complex, comparison, etc. Thus, at any point, it is possible to view the base events. In addition, filtered can be applied at any stage to eliminate data that is not deemed important for analysis.

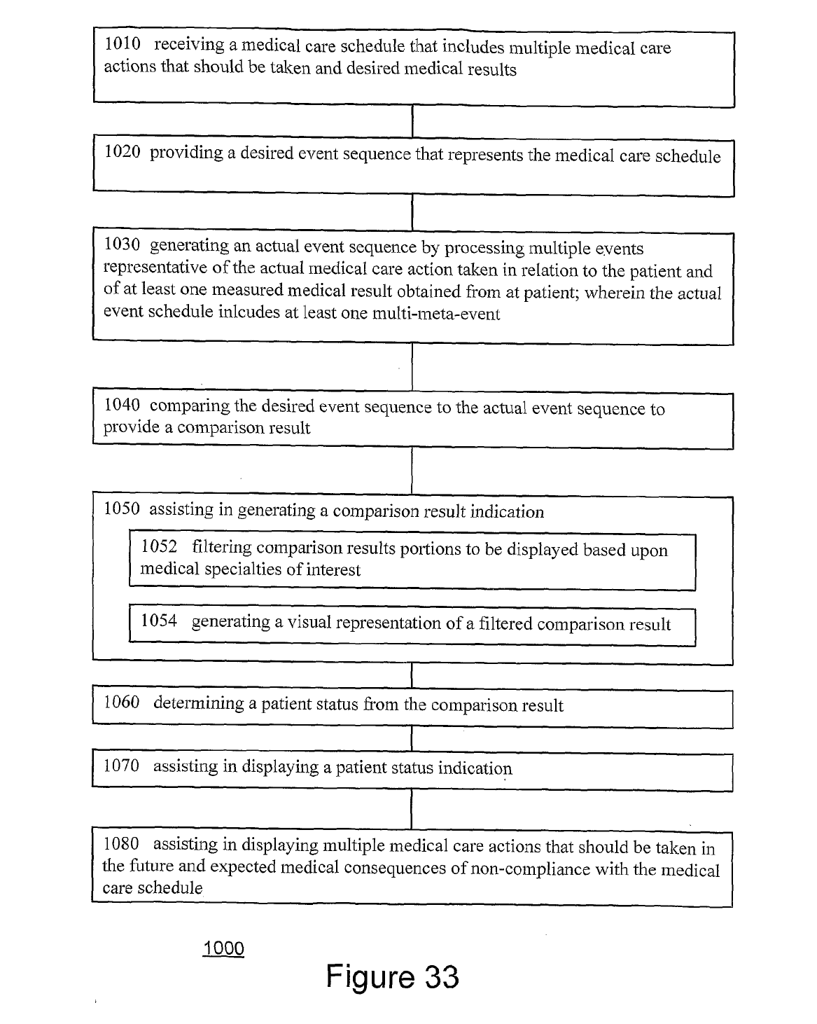

FIG. 33 illustrates method 1000 for evaluating a status of a patient according to an embodiment of the invention.

Method 1000 starts by stage 1010 of receiving a medical care schedule that includes multiple medical care actions that should be taken and desired medical results. The desired medical results can include, for example, blood pressure, glucose reading, and the like.

Stage 1010 is followed by stage 1020 of providing a desired event sequence that represents the medical care schedule. The desired event schedule includes at least one multi-meta-event. Stage 1020 can include representing the medical care schedule and the desired medical results by base events. A medical result can be represented by an event of a measurement of the medical result.

Stage 1020 can further include performing at least one of the following operations on the base events: (i) classifying base events, (ii) categorizing base events, (iii) comparing multiple base events, (iv) merging multiple base events, and (v) filtering base events. The merging of multiple events can include merging a continuous sequence of base events that equal to each other. The comparing can include generating an event that represents a difference between two consecutive base events of the same type. Various examples of these various stages are further illustrated in FIGS. 2, 3, 4 and 5.

Stage 1020 is followed by stage 1030 of generating an actual event sequence by processing multiple events representative of the actual medical care action taken in relation to the patient and of at least one measured medical result obtained from at patient; wherein the actual event schedule includes at least one multi-meta-event. Examples of actual event sequences are provided, in FIGS. 7, 8, 11, 12, 13.

A multi-meta-event is representative of an outcome of an appliance of a logic operation on multiple events or of an appliance of a logic operation on attributes of multiple events. It can include applying any Boolean or non-Boolean operation, such as but not limited to a XOR operation, a NAND operation, a NOR operation, an AND operation, a NXOR operation, a OR operation, a statistical operation, and the like.

Stage 1030 can include performing at least one of the following operations on the base events: (i) classifying base events, (ii) categorizing base events, (iii) comparing multiple base events, (iv) merging multiple base events, and (v) filtering base events. The merging of multiple events can include merging a continuous sequence of base events that equal to each other. The comparing can include generating an event that represents a difference between two consecutive base events of the same type. Stage 1030 can also include inferring a base event that represent an absence of an expected base event. Various examples of these various stages are further illustrated in FIGS. 2, 3, 4, 5 and 14. Multiple aggregated sequences can form a repository, as illustrated In FIG. 15. A date based filtering is illustrated, for example, in FIG. 16. An example of a merging operation is also illustrated in FIG. 17.

Conveniently, stage 1030 can include calculating measures associated with the patient and associated with a time frame. An example of a measure is provided in FIGS. 8, 9 and 10.

Stage 1030 is followed by stage 1040 of comparing the desired event sequence to the actual event sequence to provide a comparison result. This stage of comparison can be implemented by searching a sequence of events (that represent the desired event sequence). An example of such searches is provided in FIGS. 20, 21 and 23. An example of a sequence of events (that represent the desired event sequence) is provided in FIG. 22.

Stage 1040 can include at least one of the following stages: (i) evaluating a patient contribution to an efficiency of the medical care schedule; (ii) and evaluating a practitioner contribution to an efficiency of the medical care schedule.

The contribution can be determined from gaps between medical events that should have occurred (according to the medical care schedule) and the medical events that occurred. For example, a patient can skip various appointments with his doctor and the doctor can fail to schedule a routing check up meeting.

Stage 1040 is followed by stage 1050 of assisting in generating a comparison result indication. Stage 1050 can include storing the comparison result indication, displaying the comparison result indication, transmitting the comparison result indication to a display, transmitting the comparison indication to a storage unit, sending the comparison result to another device that generates the comparison result indication, and the like.

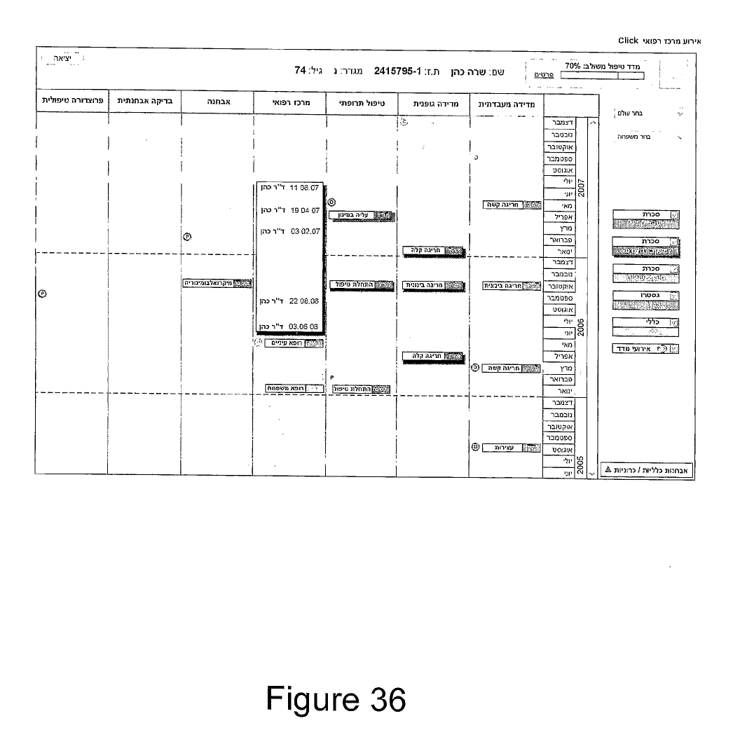

The comparison result can include a patient contribution score, a practitioner score and an overall score that indicates whether the medical care schedule is efficient. The example of FIG. 36 provides such indications.

According to an embodiment of the invention stage 1050 includes stage 1052 of filtering comparison results portions to be displayed based upon medical specialties of interest and stage 1054 of generating a visual representation of a filtered comparison result. Examples of a visual representation of such a result is provided in FIG. 36 that illustrates various base events, medical results and additional information within a calendar frame.

Stage 1050 can be followed by stage 1060 of determining a patient status from the comparison result. The status can include one or more health problems.

Stage 1060 is followed by stage 1070 of assisting in displaying a patient status indication.

Stage 1070 can include displaying the status indication, transmitting the status indication to a device that displays the status indication, sending patient status information to another device that generates the status indication, and the like.

Stage 1070 can also be followed by stage 1080 of assisting in displaying multiple medical care actions that should be taken in the future and expected medical consequences of non-compliance with the medical care schedule.

Examples of displaying medical information in a medical specialty grouped manner are provided in FIGS. 24, 25 26, 27 and 28. The term “medical specialty grouped manner” indicates that information elements are grouped according to the relevant medical specialty. The display is split to multiple parts—each part includes information elements of a certain medical specialty. The example of FIGS. 24 and 25 include a neurology portion, a nephrology portion, a vascular portion, a opthalmology portion, and a diebetic follow up portion. FIG. 27 illustrates only a portion of the information elements of FIGS. 25 and FIG. 28 illustrates even fewer information elements.

Conveniently, method 1000 includes the following stages:
a. stage 1010 of receiving a medical care data that includes any data relevant to the medical care administrated to a patient, including doctor appointments, measurements, lab tests, etc.
b. Stage 1020 of receiving information on medical care actions that should be taken and desired medical results (e.g., in the form of clinical guidelines, “measures”, etc.).
c. Stage 1030 of generating a base events sequence by processing the medical care data received in 1010 using at least one of the following operations: (i) translation of medical data to an event, associated with time (ii) filtration of data (or information related to a single event) considered irrelevant (iii) categorization of information (e.g., categorizing medications according to the ACT protocol) (iv) transformation of information (e.g., unifying units so that all financial information appears at the same currency) (v) breaking a piece of information to its core medical components, and generating a base event for each component (e.g., a doctor visit in which the doctor diagnosed the patient as suffering from a disease—the system will generate two base events: a doctor visit event, and a diagnosis event). This sequence represents the actual event sequence relevant to the patient with a close relationship to the patient data.
d. Stage 1040 of generating a processed event sequence by processing multiple base events representative of the actual medical care action taken in relation to the patient by applying at least one of the following operations: (i) merging a continuous base events that equal to each other; (ii) generating an event that represents a difference between two consecutive base events of the same type; and (iii) inferring an event that represents an absence of an expected base event.
e. Stage 1050 of assisting in displaying the patient events record (based and processed events) and the patient status indication.
f. Stage 1052 of filtering patient events record portions to be displayed based upon medical specialties of interest.
g. Stage 1054 of generating a visual representation of a filtered patient event record.
h. Stage 1060 of comparing the desired event sequence to the actual event sequence to provide a comparison result.
i. Stage 1070 of assisting in generating a comparison result indication.
j. Stage 1072 of filtering comparison results portions to be displayed based upon medical specialties of interest.
k. Stage 1074 of generating a visual representation of a filtered comparison result.
l. Stage 1080 of determining a patient status from the comparison result.
m. Stage 1090 of assisting in displaying multiple medical care actions that should be taken in the future and expected medical consequences of non-compliance with the medical care schedule

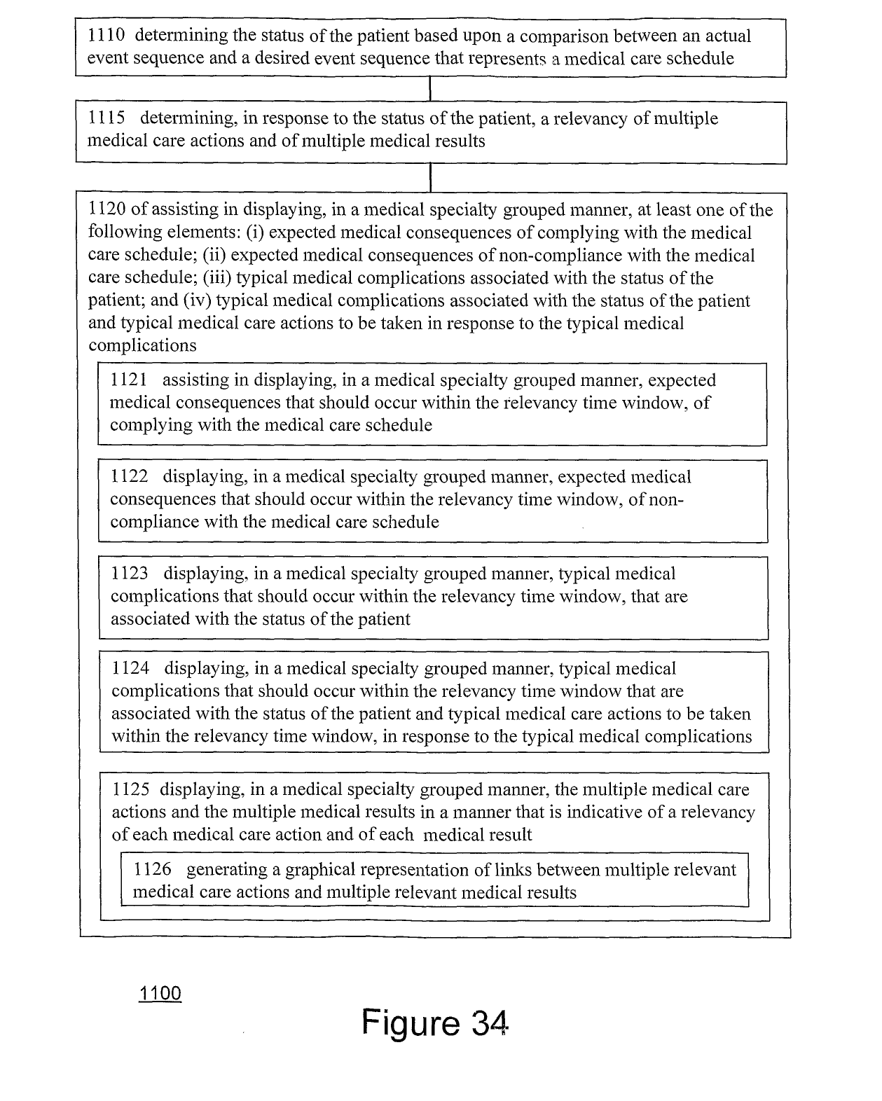

FIG. 34 illustrates method 1100 for evaluating a status of a patient according to an embodiment of the invention.

Method 1100 starts by stage 1110 of determining the status of the patient based upon a comparison between an actual event sequence and a desired event sequence that represents a medical care schedule.

Stage 110 can include executing at least some stage of method 1000 but this is not necessarily so.

Stage 1110 is followed by stage 1120 of assisting in displaying, in a medical specialty grouped manner, at least one of the following elements: (i) expected medical consequences of complying with the medical care schedule; (ii) expected medical consequences of non-compliance with the medical care schedule; (iii) typical medical complications associated with the status of the patient; and (iv) typical medical complications associated with the status of the patient and typical medical care actions to be taken in response to the typical medical complications.

Examples of displaying medical information in a medical specialty grouped manner are provided in FIGS. 24, 25 26, 27 and 28. The term “medical specialty grouped manner” indicates that information elements are grouped according to the relevant medical specialty. The display is split to multiple parts—each part includes information elements of a certain medical specialty. The example of FIGS. 24 and 25 include a neurology portion, a nephrology portion, a vascular portion, a opthalmology portion, and a diebetic follow up portion. FIG. 27 illustrates only a portion of the information elements of FIGS. 25 and FIG. 28 illustrates even fewer information elements.

FIG. 34 also illustrates optional stage 1115 of determining, in response to the status of the patient, a relevancy of multiple medical care actions and of multiple medical results. Stage 1115 is followed by stage 1120 that in turn can include stage 1125 of displaying, in a medical specialty grouped manner, the multiple medical care actions and the multiple medical results in a manner that is indicative of a relevancy of each medical care action and of each medical result.

Stage 1125 can include stage 1126 of generating a graphical representation of links between multiple relevant medical care actions and multiple relevant medical results. An example of a result of the execution of stages 1115, 1125 and 116 is illustrated in FIGS. 26, 27 and 28 in which relevant medical care actions and multiple relevant medical results are linked to each other. In FIGS. 27 and 28 many irrelevant information element are not shown.

Stage 1115 can also includes determining a relevancy time window. In this case stage 1120 can include at least one out of stage 1121, 1122, 1123, and 1124.

Stage 1121 includes assisting in displaying, in a medical specialty grouped manner, expected medical consequences that should occur within the relevancy time window, of complying with the medical care schedule. FIG. 28 illustrates an imposing of a time window that filters out information elements that do not belong an relatively immediate follow up stages.

Stage 1122 includes displaying, in a medical specialty grouped manner, expected medical consequences that should occur within the relevancy time window, of non-compliance with the medical care schedule.

Stage 1123 includes displaying, in a medical specialty grouped manner, typical medical complications that should occur within the relevancy time window, that are associated with the status of the patient.

Stage 1124 includes displaying, in a medical specialty grouped manner, typical medical complications that should occur within the relevancy time window that are associated with the status of the patient and typical medical care actions to be taken within the relevancy time window, in response to the typical medical complications.

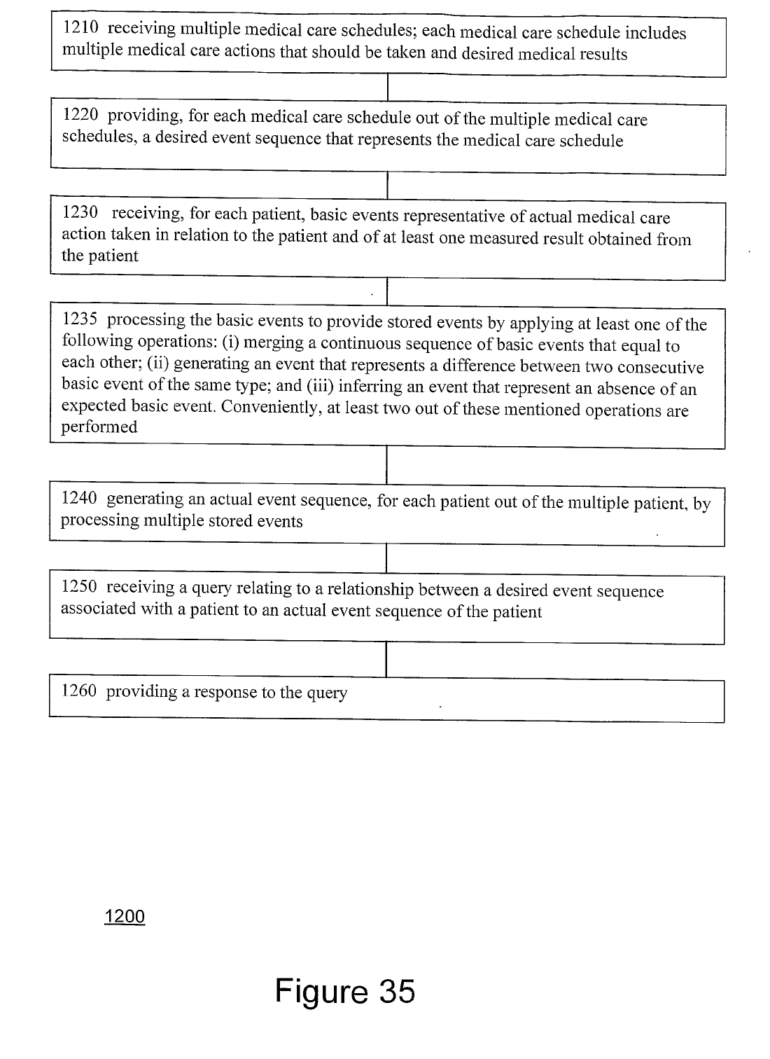

FIG. 35 illustrates method 1200 for generating a data structure indicative of health of multiple patients according to an embodiment of the invention.

Method 1200 starts by stage 1210 of receiving multiple medical care schedules; each medical care schedule includes multiple medical care actions that should be taken and desired medical results.

Stage 1210 is followed by stage 1220 of providing, for each medical care schedule out of the multiple medical care schedules, a desired event sequence that represents the medical care schedule.

Stage 1220 is followed by stage 1230 of receiving, for each patient, base events representative of actual medical care action taken in relation to the patient and of at least one measured result obtained from the patient. Examples of actual event sequences are provided, in FIGS. 7, 8, 11, 12, 13.

Stage 1230 is followed by stage 1235 of processing the base events to provide stored events by applying at least one of the following operations: (i) merging a continuous sequence of base events that equal to each other; (ii) generating an event that represents a difference between two consecutive base event of the same type; and (iii) inferring an event that represent an absence of an expected base event. Conveniently, at least two out of these mentioned operations are performed. Yet according to another embodiment of the invention stage 1230 includes executing all three operations. Various examples of these various stages are further illustrated in FIGS. 2, 3, 4, 5 and 14. Multiple aggregated sequences can form a repository, as illustrated In FIG. 15. A date based filtering is illustrated, for example, in FIG. 16. An example of a merging operation is also illustrated in FIG. 17.

Stage 1235 is followed by stage 1240 of generating an actual event sequence, for each patient out of the multiple patient, by processing multiple stored events.

Stage 1240 is followed by stage 1250 of receiving a query relating to a relationship between a desired event sequence associated with a patient to an actual event sequence of the patient. Various samples of queries were discussed above. The query can involve a search such as those that are provided in FIGS. 20, 21 and 23. An example of a sequence of events (that represent the desired event sequence) is provided in FIG. 22.

Stage 1250 is followed by stage 1260 of providing a response to the query. Examples of a response are illustrated in FIGS. 25, 26, 27, 28 and 36.

Stage 1260 can include assisting in displaying, in a medical specialty grouped manner, at least one element out of the following elements: (i) expected medical consequences of complying with the medical care schedule; (ii) expected medical consequences of non-compliance with the medical care schedule; (iii) typical medical complications associated with the status of the patient; and (iv) typical medical complications associated with the status of the patient and typical medical care actions to be taken in response to the typical medical complications.

Examples of displaying medical information in a medical specialty grouped manner are provided in FIGS. 24, 25 26, 27 and 28. The term “medical specialty grouped manner” indicates that information elements are grouped according to the relevant medical specialty. The display is split to multiple parts—each part includes information elements of a certain medical specialty. The example of FIGS. 24 and 25 include a neurology portion, a nephrology portion, a vascular portion, a opthalmology portion, and a diebetic follow up portion. FIG. 27 illustrates only a portion of the information elements of FIGS. 25 and FIG. 28 illustrates even fewer information elements.

FIG. 36 illustrates a report that includes lab test results, physical examination results, medical treatment information, visits to a medical center and diagnosis according to an embodiment of the invention.

FIG. 36 includes a table. The rows of the table are indicative of the time in which a base event occurred. The colums of the table include: physical examination results column, medical treatment information column, visits to a medical center column and diagnosis column.

FIG. 36 also illustrated a patient identification details (name, ID, gender and age), a patient contribution indication (indicative of the contribution of the patient to an efficiency of the medical care schedule) a practitioner contribution indication (indicative of the contribution of the practitioner to an efficiency of the medical care schedule), and an overall efficiency score.

Events that represent physical examination results or physical examination results can indicate the type of examination (sugar test, gastronomical tests, blob pressure, and the like, the examination result (not shown) or a deviation of the examination result from a desired result.

Events that represent the medical treatment can indicate which medicines that patient was requested to take but can also include only significant events in the medical treatment such as beginning of the treatment, dosage changes, medicine changes, end of the treatment.

The letters “D” and “P” can indicate whether the practitioner (doctor) or the patient should be held responsible to the occurrence or absence of an event. The patient, for example, can be responsible to start taking a medicine, to arrive to a schedule meeting, and the like.

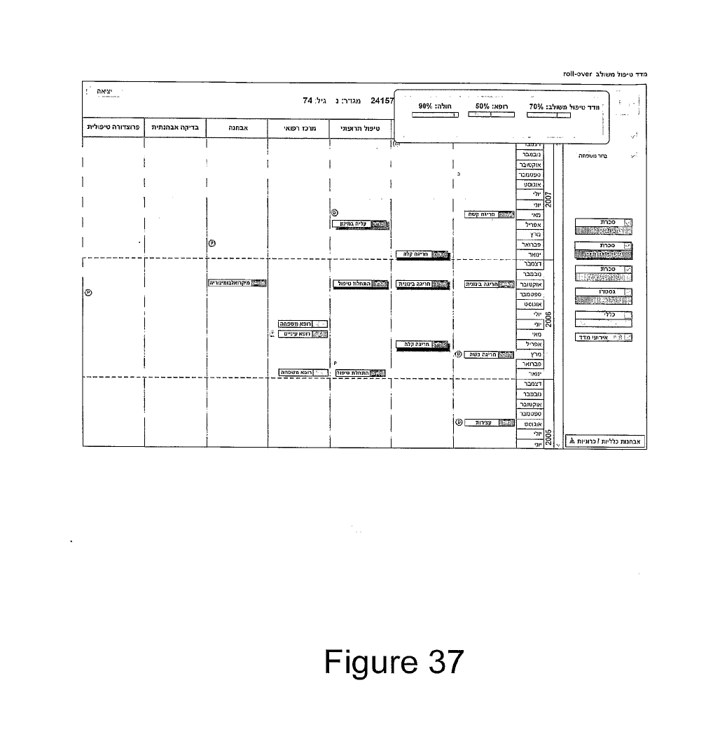

FIG. 37 also illustrates a report that includes lab test results, physical examination results, medical treatment information, visits to a medical center and diagnosis according to an embodiment of the invention.

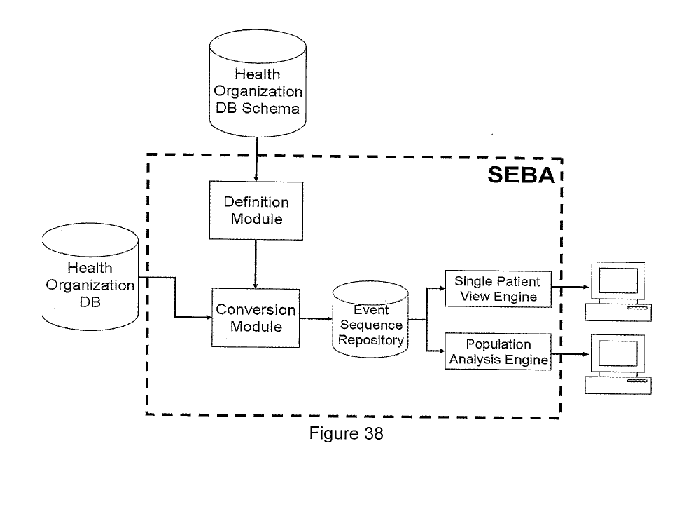

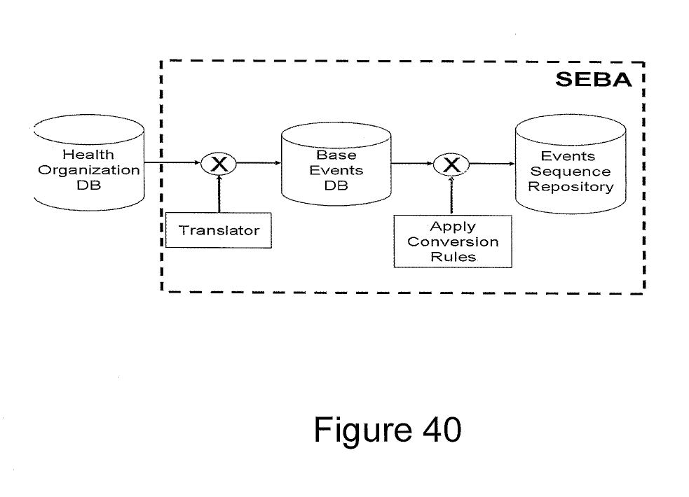

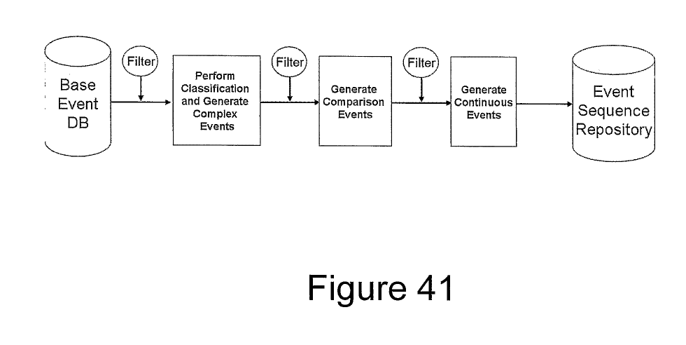

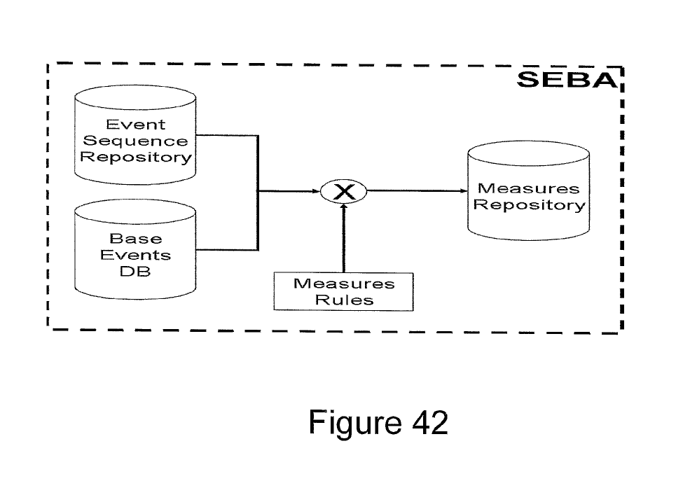

FIG. 38-43 further illustrate some stages and data structures according to an embodiment of the invention.

The system has two functions—(i) database and repositories generation—includes the definition and creation of the base events database, the events sequence and measure sequence repository; and (ii) definition and execution of queries that are performed on the databases and repositories and presentation of the queries results.

Error! Reference source not found.38 provides an overview of the system. Health Organization data is converted to the system repositories via a Conversion Definition module (which sets the conversion rules) and the Conversion module (which performs the actual conversion). The system processes data that arrives from the health organization DB (as schema and actual data). The Definition and Conversion Modules translate the health organization DB information into the systems repositories (e.g., the Event Sequence Repository). Various Query Engines can then access these repositories and present the results to the users.

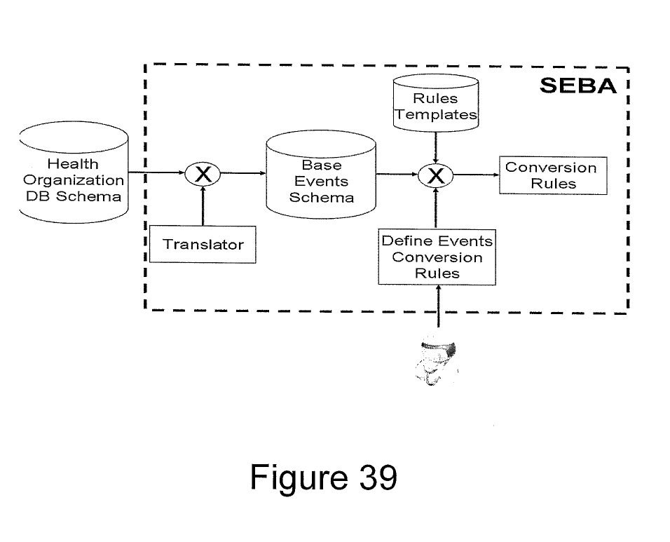

A Definition module is described in FIG. 39. The health organization DB schema is translated into system base events schema. The user can then define how the base events will be converted into sequence events using pre-defined rules templates. Once the conversion rules are defined, it is possible to convert the health organization database into the systems Event Sequence Repository (ESR).

The conversion process and conversion module are described in Error! Reference source not found.40 and 41. These figure shows how events are translated and put into a Base Event DB, and then they rules defined earlier are being applied and convert the base events to events that conform to the ESR.

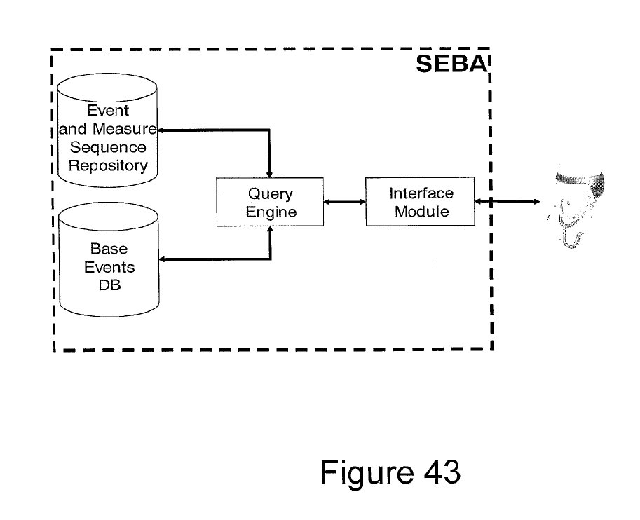

Error! Reference source not found.1 shows the steps by which the base events are converted. Each one of the conversion blocks appear in the figure represents a single type of rules template that is configured during the conversion definition process. Measures are defined and created in a similar way to events in the ESR. 42 describes a generation of the Measure Repository. Please note that measures may require the ESR as well as the Base Event Repository. Once the Base Events DB, and the ESR and the Measures Repositories are created, users can form queries and analyze the results they receive (illustrated in FIG. 43). A Single Patient and the Population Analysis view engines conform to the same structure, however, they differ in the type of queries that are performed. The single patient view analyzes, filters, and displays events that are related to a single patient only, while the Population Analysis module processes information that is related to multiple patients and possibly to the whole patients population.

The present invention can be practiced by employing conventional tools, methodology, and components. Accordingly, the details of such tools, component, and methodology are not set forth herein in detail. In the previous descriptions, numerous specific details are set forth, in order to provide a thorough understanding of the present invention. However, it should be recognized that the present invention might be practiced without resorting to the details specifically set forth.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

1. A method for evaluating a status of a patient, the method comprises:
receiving a medical care schedule that comprises multiple medical care actions that should be taken and desired medical results;
providing a desired event sequence that represents the medical care schedule; wherein the desired event schedule comprises at least one multi-meta-event;
generating an actual event sequence by processing multiple events representative of the actual medical care action taken in relation to the patient and of at least one measured medical result obtained from at patient; wherein the actual event schedule comprises at least one multi-meta-event;
comparing the desired event sequence to the actual event sequence to provide a comparison result; and
assisting in generating a comparison result indication;
wherein a multi-meta-event is representative of an outcome of an appliance of a logic operation on multiple events or of an appliance of a logic operation on attributes of multiple events.

2. (canceled)

3. (canceled)

4. (canceled)

5. The method according to claim 1 comprising:
filtering comparison results portions to be displayed based upon medical specialties of interest; and
generating a visual representation of a filtered comparison result.

6. (canceled)

7. (canceled)

8. The method according to claim 1 comprising evaluating a patient contribution to an efficiency of the medical care schedule and evaluating a practitioner contribution to an efficiency of the medical care schedule.

9. The method according to claim 1 comprising evaluating an efficiency of the medical care schedule, evaluating a patient contribution to an efficiency of the medical care schedule and evaluating a practitioner contribution to an efficiency of the medical care schedule.

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. A computer readable medium that stores computer readable instructions for:
receiving a medical care schedule that comprises multiple medical care actions that should be taken and desired medical results;
providing a desired event sequence that represents the medical care schedule; wherein the desired event schedule comprises at least one multi-meta-event;
generating an actual event sequence by processing multiple events representative of the actual medical care action taken in relation to the patient and of at least one measured medical result obtained from at patient; wherein the actual event schedule comprises at least one multi-meta-event;
comparing the desired event sequence to the actual event sequence to provide a comparison result; and
assisting in generating a comparison result indication;
wherein a multi-meta-event is representative of an outcome of an appliance of a logic operation on multiple events or of an appliance of a logic operation on attributes of multiple events.

27. The computer readable medium according to claim 26 that stores computer readable instructions for classifying base events, categorizing base events, comparing multiple base events, merging multiple base events, and filtering base events.

28. The computer readable medium according to claim 26 that stores computer readable instructions for inferring base events in response to the desired event sequence.

29. The computer readable medium according to claim 26 that stores computer readable instructions for calculating measures associated with the patient and associated with a time frame.

30. The computer readable medium according to claim 26 that stores computer readable instructions for:
filtering comparison results portions to be displayed based upon medical specialties of interest; and
generating a visual representation of a filtered comparison result.

31. The computer readable medium according to claim 26 that stores computer readable instructions for determining a patient status from the comparison result and assisting in displaying a patient status indication.

32. (canceled)

33. The computer readable medium according to claim 26 that stores computer readable instructions for evaluating a patient contribution to an efficiency of the medical care schedule and evaluating a practitioner contribution to an efficiency of the medical care schedule.

34. The computer readable medium according to claim 26 that stores computer readable instructions for evaluating an efficiency of the medical care schedule, evaluating a patient contribution to an efficiency of the medical care schedule and evaluating a practitioner contribution to an efficiency of the medical care schedule.

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. A system for evaluating a status of a patient, the system comprises:
a memory unit for storing a medical care schedule that comprises multiple medical care actions that should be taken and desired medical results;
a processor that is adapted to:
provide a desired event sequence that represents the medical care schedule; wherein the desired event schedule comprises at least one multi-meta-event;
generate an actual event sequence by processing multiple events representative of the actual medical care action taken in relation to the patient and of at least one measured medical result obtained from at patient; wherein the actual event schedule comprises at least one multi-meta-event;
compare the desired event sequence to the actual event sequence to provide a comparison result; and
assist in generating a comparison result indication;
wherein a multi-meta-event is representative of an outcome of an appliance of a logic operation on multiple events or of an appliance of a logic operation on attributes of multiple events.

52. The system according to claim 51 wherein the processor is adapted to classify base events, categorizing base events, comparing multiple base events, merging multiple base events, and filtering base events.

53. The system according to claim 51 wherein the processor is adapted to infer base events in response to the desired event sequence.

54. (canceled)

55. The system according to claim 51 wherein the processor is adapted to:
filter comparison results portions to be displayed based upon medical specialties of interest; and
generate a visual representation of a filtered comparison result.

56. The system according to claim 51 wherein the processor is adapted to determine a patient status from the comparison result and assisting in displaying a patient status indication.

57. The system according to claim 56 wherein the processor is adapted to assist in displaying multiple medical care actions that should be taken in the future and expected medical consequences of non-compliance with the medical care schedule.

58. The system according to claim 51 wherein the processor is adapted to evaluate a patient contribution to an efficiency of the medical care schedule and evaluating a practitioner contribution to an efficiency of the medical care schedule.

59. The system according to claim 51 wherein the processor is adapted to evaluate an efficiency of the medical care schedule, evaluating a patient contribution to an efficiency of the medical care schedule and evaluating a practitioner contribution to an efficiency of the medical care schedule.

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)
